(19) United States
(12) Patent Application Publication
(10) Pub. No.: US 2010/0076878 A1
(43) Pub. Date: Mar. 25, 2010

(54) APPARATUS AND METHOD FOR IMPLEMENTING A ROAD PRICING SCHEME

(75) Inventors: Jonathan Charles Burr, Cheshire (GB); Alan George Slater, Bolton (GB)

Correspondence Address: MCDERMOTT WILL & EMERY LLP, 18191 VON KARMAN AVE., SUITE 500, IRVINE, CA, 92612-7108, US

(73) Assignee: ITIS HOLDINGS PLC, Altrincham, Cheshire (GB)

(21) Appl. No.: 12/441,137

(22) PCT Filed: Sep. 12, 2007
(86) PCT No.: PCT/GB2007/003476

§ 371 Date: Nov. 30, 2009

(30) Foreign Application Priority Data
Sep. 12, 2006 (GB) 0617952.7
Apr. 20, 2007 (GB) 0707717.5

(51) Int. Cl. G06Q 99/00; G06F 7/00; G01C 21/36; G06F 17/00; G06Q 10/00; G01S 19/24; G06Q 30/00; H04W 4/12

(52) U.S. Cl. 705/34; 701/123; 701/29; 701/33; 705/412; 342/357.07; 701/35; 705/1.1; 455/466

(57) ABSTRACT

A vehicle monitoring device, comprising: a location device for determining location data indicating a location of a vehicle during a journey between an origin point and a destination point; a fuel consumption device for determining fuel consumption data indicating an amount of fuel consumed by the vehicle during the journey, or an emission measurement device for determining emission data indicating an amount of emission produced by the vehicle during the journey; and a vehicle monitoring processor for receiving and processing the location data and the fuel consumption data. A vehicle charging device, comprising: a vehicle charging processor for receiving and processing location data indicating a location of a vehicle comprising a vehicle monitoring device during a journey between an origin point and a destination point, and fuel consumption data indicating an amount of fuel consumed by the vehicle during the journey from the vehicle monitoring device or emission data indicating an amount of emission produced by the vehicle during the journey from the vehicle monitoring device; and a road fee calculator for calculating a fee associated with the at least one vehicle monitoring device based on the received data.

### TECHNICAL FIELD

The present invention relates to an apparatus and method for implementing a road pricing scheme. In particular, the invention relates to an apparatus and method for implementing a road pricing scheme incorporating fuel consumption data and/or emission data. The current invention also provides a means to consolidate all existing road charging schemes into one administrative process.

### BACKGROUND

There are several known methods for charging for the use of roads by vehicles.

‘Blanket charging’ schemes are where a vehicle user pays a fixed fee and includes such methods as Road Fund Licensing (RFL) which is a charge per vehicle to use the road system for a defined period of time. The collection of these fees may be centralised and linked to other requirements such as valid insurance and test certificates proving the road worthiness of the vehicle. These schemes are per vehicle and are often criticised because they take no account of total mileage undertaken in the period, the location in which the vehicle is used or the time at which the vehicle is used. They have, however, been able to vary the charge by type of vehicle and the average carbon emissions of the vehicle as determined by a manufacturer's or independent test.

‘Closed tolling’ charging schemes are where a user pays a fee to use a specific road or section of road by means of entering or exiting the road via toll booths at which the fee is collected. The fee payable may be loosely related to the distance traveled, the type of vehicle and sometimes the time of day. Such a scheme requires capital expenditure on the establishment of a toll booth area (to avoid a bottleneck) and staff for both fee collection and traffic monitoring. The additional capital expenditure and cost of labour means that ‘closed tolling’ is not economically feasible on a large scale involving a plurality of roads.

‘Point charging’ or ‘point tolling’ charging schemes are where a user pays a fee to cross a bridge or travel through a tunnel. Such charges are normally levied to recover the capital cost and maintenance of the facility provided and considered equitable by users if varied by type of vehicle. Again, similar to ‘closed tolling’ the additional capital expenditure and cost of labour means that ‘point charging’ is not economically feasible on a large scale involving a plurality of roads.

‘Area pricing’ or ‘entry permit charging’ are schemes where the user pays a fee to enter and travel within a particular geographic zone with a vehicle possibly during particular days of the week and times of the day. This type of scheme requires both a method to police entry and a method for collecting the fee. The simple solution is barriers (with fee collection facilities) on all entry routes to the area. The complex solution is multiple cameras on all entry routes collecting number plate data and fees paid for each vehicle being matched to the number plates by computer. Both these schemes require substantial capital costs and may not be economically feasible on a large scale involving a plurality of roads.

‘Distance based’ charging schemes are where the user pays a fee based upon the distance traveled in a defined period for a particular type of vehicle used. The distance information may be obtained from the Global Positioning Satellite system (GPS). Such schemes do not determine the actual roads used or the day or time any journey was undertaken. This method requires an on-board vehicle GPS tracker, a means of recording and accumulating the kilometres/miles driven and a means of issuing such travel distances to a charging unit. There is no real verification process upon which any charges levied may be justified, and inaccurate data leads to inaccurate charges.

A ‘Time-Distance-Place’ (TDP) road charging scheme determines the time period during which an user is travelling, the distance traveled on each journey and the actual roads traveled, and calculates a fee based on this data. A GPS system is used in combination with On-Board Vehicle Monitoring Devices (OBD) to track each journey, then sends both geographic data (longitude and latitude) and time data to an Independent Monitoring Service (IMS). The IMS uses Digital Mapping (DM) to determine the roads upon which the journey was taken, on what day and at what time. The IMS then generates a fee for the journey based upon the time period during which the user was travelling, the distance traveled on the journey and the actual roads traveled upon.

‘Penalty systems’ also exist where a specific restriction such as a bus lane, lane for vehicles with two occupants or lorry bans are imposed on specific days and times of the day. These systems limit access for particular types of vehicles and are often policed by cameras or traffic wardens and require additional capital expenditure and cost of labour and are not economically feasible on a large scale involving a plurality of roads.

One serious issue with all the road pricing schemes described above is that all the road pricing charges are in addition to existing motoring taxation. In the UK, for example but not limited to, there are many taxes on vehicle ownership and use; the initial purchase of a car attracts car tax and VAT, there is the Road Fund Licence (RFL), insurance tax on motor insurance, excise tax and VAT on fuel, VAT on vehicle servicing, maintenance, spares and consumables and parking fees also including VAT.

One fundamental objective of any national road pricing scheme is that it should not at the macro level increase the overall tax burden on the motorist. This implies, for example, that if there is the imposition of charges for the use of congested roads such a revenue gain will be offset by a credit (or reduced fee) for such activities as lower overall mileage in a period, use of non-congested roads, or travelling at non-peak times. Thus, there needs to be an incentive for the motorist to switch from any current motoring taxation to a national road pricing scheme.

However, not one of the road pricing schemes described above may feasibly be used throughout the country in an economic manner for all types of vehicles using the road network on any day at any time. In addition each charging method described above is mutually exclusive due to the specific nature of the capital requirements and the tasks undertaken by any staff required to operate or administer the system.

Embodiments of the invention seek to provide improved methods and apparatus for use in road pricing schemes, and in particular methods and apparatus for use in a national road pricing scheme.

### SUMMARY

In one embodiment of the invention a vehicle monitoring device is provided. The vehicle monitoring device comprising: a location device for, determining location data indicating a location of a vehicle during a journey between an origin point and a destination point; a fuel consumption device for determining fuel consumption data indicating an amount of fuel consumed by the vehicle during the journey; and a vehicle monitoring processor for receiving and processing the location data and the fuel consumption data.

In another embodiment the fuel consumption device comprises a fuel flow meter.

In another embodiment the fuel consumption device comprises a fuel pump.

In another embodiment the vehicle monitoring device further comprising: an emission measurement device for determining emission data indicating an amount of emission produced by the vehicle during the journey, and wherein the vehicle monitoring processor is capable of receiving and processing the emission data.

In another embodiment the emission measurement device determines the amount of emission produced by the vehicle by measuring vehicle exhaust gases.

In another embodiment the emission measurement device determines the amount of emission produced by the vehicle by measuring carbon particles in the vehicles exhaust gases.

In another embodiment the emission measurement device determines the amount of emission produced by the vehicle by measuring air quality surrounding the vehicle.

In another embodiment the emission measurement device measures nitrogen dioxide emissions.

In another embodiment the emission measurement device measures sulphur dioxide emissions.

In another embodiment the emission measurement device measures carbon emissions.

In another embodiment the vehicle monitoring device further comprises: a distance measurement device for determining distance data indicating a distance traveled by the vehicle during the journey, and wherein the vehicle monitoring processor is capable of receiving and processing the distance data.

In another embodiment the vehicle monitoring processor compares the distance data with the location data.

In another embodiment the vehicle monitoring device further comprises: a communication device for enabling two way communication between the vehicle monitoring device and a remote vehicle charging device.

In another embodiment the communication device comprises a General Packet Radio System (GPRS) device.

In another embodiment the communication device comprises a Short Message Service (SMS) device.

In another embodiment the communication device comprises a 3G wireless system.

In another embodiment the vehicle monitoring processor comprises a storage device for storing the received data.

In another embodiment the vehicle monitoring processor transfers the stored data to a remote vehicle charging device at predetermined intervals.

In another embodiment the vehicle monitoring processor receives the data at predetermined intervals.

In another embodiment the vehicle monitoring processor requests the data at predetermined intervals.

In another embodiment the predetermined intervals comprises once every two minutes; once an hour; once a day; once a week; at an end of the journey; after a predetermined distance traveled.

In another embodiment the vehicle monitoring processor receives the data in real time.

In another embodiment the vehicle monitoring processor requests the data in real time.

In another embodiment the vehicle monitoring device further comprises: a road toll device for determining road toll data identifying road tolls passed during the journey, and wherein the vehicle monitoring processor is capable of receiving and processing the road toll data.

In another embodiment the vehicle monitoring device further comprises: a presentation device for presenting data to a user in accordance with instructions from the vehicle monitoring processor.

In another embodiment the presentation device comprises a visual display device.

In another embodiment the presentation device comprises an audio device.

In another embodiment the vehicle monitoring device further comprises: a tamper detection device, and wherein the vehicle monitoring processor is capable of receiving and processing tamper detection data from the tamper detection device.

In another embodiment the tamper detection device compares the received data received at the vehicle monitoring processor with expected data to determine whether the received data has been tampered with.

In another embodiment the expected data is determined based on historical received data.

In another embodiment wherein the tamper detection device comprises: a driver recognition device for determining whether a driver is a registered driver.

In another embodiment the vehicle monitoring device further comprises: a route calculation device for determining a route for the journey, and wherein the vehicle monitoring processor is capable of receiving and processing the route.

In another embodiment the route calculating device is capable of determining an estimated cheapest route for the journey.

In another embodiment the route calculating device is capable of indicating an alternative start time.

In another embodiment the route calculating device is capable of determining an estimated quickest route for the journey.

In another embodiment the route calculating device is capable of determining an estimated shortest route for the journey.

In another embodiment the route calculating device is capable of determining an estimated lowest emission route for the journey.

In another embodiment the route calculating device is capable of determining an estimated lowest fuel consumption route for the journey.

In another embodiment the route calculating device is capable of replanning the route during the journey.

In another embodiment the vehicle monitoring device, further comprises: a road fee calculator for calculating a fee for the journey based on the received data.

In another embodiment the vehicle monitoring device, further comprises: a road fee database for storing road fee data associated with road sections of the journey, and wherein the road pricing fee calculator calculates the fee for the journey based on the received data and the road fee data.

In another embodiment the vehicle monitoring device, further comprises: a vehicle attribute storage device for storing attribute data about the vehicle.

In another embodiment the vehicle attribute data comprises at least one of: type of vehicle; make of vehicle; model of vehicle; engine size; fuel type; vehicle age; manufacturer predicted fuel consumption data; manufacturer predicted emission data.

In another embodiment the vehicle monitoring device, further comprises: a map matching device, and wherein the location data is compared with map data stored in the map matching device to determine road sections traveled by the vehicle during the journey.

In another embodiment the location data further indicates time and date data of the vehicle at the location during the journey.

In one embodiment of the invention a vehicle monitoring device is provided. The vehicle monitoring device comprising: a location device for determining location data indicating a location of a vehicle during a journey between an origin point and a destination point; an emission measurement device for determining emission data indicating an amount of emission produced by the vehicle during the journey; and a vehicle monitoring processor for receiving and, processing the location data and the emission data.

In another embodiment the emission measurement device determines the amount of emission produced by the vehicle by measuring vehicle exhaust gases.

In another embodiment the emission measurement device determines the amount of emission produced by the vehicle by measuring carbon particles in the vehicles exhaust gases.

In another embodiment the emission measurement device determines the amount of emission produced by the vehicle by measuring air quality surrounding the vehicle.

In another embodiment the emission measurement device measures nitrogen dioxide emissions.

In another embodiment the emission measurement device measures sulphur dioxide emissions.

In another embodiment the emission measurement device measures carbon emissions.

In another embodiment the vehicle monitoring device further comprises: a distance measurement device for determining distance data indicating a distance traveled by the vehicle during the journey, and wherein the vehicle monitoring processor is capable of receiving and processing the distance data.

In another embodiment the vehicle monitoring processor compares the distance data with the location data.

In another embodiment the vehicle monitoring device further comprises: a communication device for enabling two way communication between the vehicle monitoring device and a remote vehicle charging device.

In another embodiment the communication device comprises a General Packet Radio System (GPRS) device.

In another embodiment the communication device comprises a Short Message Service (SMS) device.

In another embodiment the communication device comprises a 3G wireless system.

In another embodiment wherein the vehicle monitoring processor comprises a storage device for storing the received data.

In another embodiment the vehicle monitoring processor transfers the stored data to a remote vehicle charging device at predetermined intervals.

In another embodiment the vehicle monitoring processor receives the data at predetermined intervals.

In another embodiment the vehicle monitoring processor requests the data at predetermined intervals.

In another embodiment the predetermined intervals comprises once every two minutes; once an hour; once a day; once a week; at an end of the journey; after a predetermined distance traveled.

In another embodiment the vehicle monitoring processor receives the data in real time.

In another embodiment the vehicle monitoring processor requests the data in real time.

In another embodiment the vehicle monitoring device further comprises: a road toll device for determining road toll data identifying road tolls passed during the journey, and wherein the vehicle monitoring processor is capable of receiving and processing the road toll data.

In another embodiment the vehicle monitoring device further comprises: a presentation device for presenting data to a user in accordance with instructions from the vehicle monitoring processor.

In another embodiment the presentation device comprises a visual display device.

In another embodiment the presentation device comprises an audio device.

In another embodiment the vehicle monitoring device further comprises: a tamper detection device, and wherein the vehicle monitoring processor is capable of receiving and processing tamper detection data from the tamper detection device.

In another embodiment the tamper detection device compares the data received at the vehicle monitoring processor with, expected vehicle data to determine whether the received data has been tampered with.

In another embodiment the expected data is determined based on historical received data.

In another embodiment the tamper detection device comprises: a driver recognition device for determining whether a driver is a registered driver.

In another embodiment the vehicle monitoring device further comprises: a route calculating device for determining a route for the journey, and wherein the vehicle monitoring processor is capable of receiving and processing the route.

In another embodiment the route calculating device is capable of determining an estimated cheapest route for the journey.

In another embodiment the route calculating device is capable of indicating an alternative start time.

In another embodiment the route calculating device is capable of determining an estimated quickest route for the journey.

In another embodiment the route calculating device is capable of determining an estimated shortest route for the journey.

In another embodiment the route calculating device is capable of determining an estimated lowest emission route for the journey.

In another embodiment the route calculating device is capable of replanning the route during the journey.

In another embodiment the vehicle monitoring device further comprises: a road fee calculator for calculating a fee for the journey based on the received data.

In another embodiment the vehicle monitoring device further comprises: a road fee database for storing road fee data associated with road sections of the journey, and wherein the road pricing fee calculator calculates the fee for the journey based on the received data and the road fee data.

In another embodiment the vehicle monitoring device further comprises: a vehicle attribute storage device for storing attribute data about the vehicle.

In another embodiment the vehicle attribute data comprises at least one of: type of vehicle; make of vehicle; model of vehicle; engine size; fuel type; vehicle age; manufacturer predicted fuel consumption data; manufacturer predicted emission data.

In another embodiment the vehicle monitoring device further comprises: a map matching device, and wherein the location data is compared with map data stored in the map matching device to determine road sections traveled by the vehicle during the journey.

In another embodiment the location data further indicates time and date data of the vehicle at the location during the journey.

In one embodiment of the invention a vehicle is provided. The vehicle comprising vehicle comprising a vehicle monitoring device described above.

In one embodiment of the invention a vehicle charging device is provided. The vehicle charging device comprising a vehicle charging processor for receiving and processing location data indicating a location of a vehicle comprising a vehicle monitoring device during a journey between an origin point and a destination point, and fuel consumption data indicating an amount of fuel consumed by the vehicle during the journey from the vehicle monitoring device; and a road fee calculator for calculating a fee associated with the at least one vehicle monitoring device based on the received data.

In another embodiment the vehicle charging device further comprises: a received data storage device for storing the received data.

In another embodiment the location data further indicates time and date data associated with the journey.

In another embodiment the vehicle charging processor is capable of receiving and processing emission data indicating an amount of emission produced by the vehicle during the journey from the vehicle monitoring device.

In another embodiment the vehicle charging device further comprises: a vehicle attribute storage device for storing attribute data about a vehicle comprising the at least one vehicle monitoring device.

In another embodiment the vehicle attribute data comprises at, least one of: type of vehicle; make of vehicle; model of vehicle; engine size; fuel type; vehicle age; manufacturer predicted fuel consumption data; manufacturer predicted emission data.

In another embodiment the road fee calculator calculates the fee associated with the at least one vehicle monitoring device based on the received data and the attribute data.

In another embodiment the fee may be a credit or a debit.

In another embodiment the vehicle charging processor is capable of receiving an unique driver identifier from the at least one vehicle monitoring device.

In another embodiment the vehicle charging processor is capable of receiving an unique vehicle identifier from the at least one vehicle monitoring device.

In another embodiment the vehicle charging device further comprises: a road fee database for storing road fee data associated with road sections, and wherein the road pricing fee calculator calculates the fee associated with the at least one vehicle monitoring device based on the received data and the road fee data.

In another embodiment the vehicle charging device further comprises: a road toll storage device for storing toll fee data associated with road tolls.

In another embodiment the vehicle charging processor is capable of receiving road toll data from the at least one vehicle monitoring device, and wherein the road fee calculator calculates the fee associated with the at least one vehicle monitoring device based on the road toll data and the toll fee data.

In another embodiment the vehicle charging device further comprises: a communication device for enabling two way communication between the vehicle charging device and the vehicle monitoring device, and wherein the vehicle charging device provides fee data to the vehicle monitoring device.

In another embodiment the vehicle charging device further comprises: a registration device for registering a driver with the vehicle charging device.

In another embodiment the vehicle charging device further comprises: a registration device for registering the vehicle with the vehicle charging device.

In another embodiment the vehicle charging device further comprises: a validation device.

In another embodiment the validation device comprises a map matching device, and wherein the location data is compared with map data stored in the map matching device to determine road sections traveled by the vehicle during the journey.

In another embodiment the validation device compares the fuel consumption data with vehicle manufacture fuel consumption data stored in the vehicle attribute storage device.

In another embodiment the validation device compares the fuel consumption data with historical fuel consumption data stored in the received data storage device.

In another embodiment the validation device compares road toll data with data received from road tolls.

In another embodiment the validation device compares the emission data with vehicle manufacture emission data stored at the vehicle attribute storage device.

In another embodiment the validation device compares the emission data with historical emission data stored in the received data storage device.

In another embodiment the vehicle charging device further comprises: a historical road data storage device comprising historical data regarding a plurality of roads.

In another embodiment the vehicle charging device further comprises: a tamper detection device for determining whether the received data has been tampered with.

In another embodiment the tamper detection device compares the received data with historical received data.

In another embodiment the tamper detection device compares the received data from the vehicle monitoring device with received data from another vehicle monitoring device.

In another embodiment the tamper detection device compares the data received from the at least one vehicle monitoring device with third party data.

In another embodiment the third party data comprises at least one of average speed data, and/or traffic event data.

In another embodiment the vehicle charging device further comprises: an invoicing unit for receiving the calculated fee associated with the at least one vehicle monitoring device from the road pricing fee calculator, and for invoicing a driver of the vehicle.

In another embodiment the vehicle charging processor receives the data from the at least one vehicle monitoring device at predetermined intervals.

In another embodiment the vehicle charging processor requests the data from vehicle monitoring device at predetermined intervals.

In another embodiment the predetermined intervals comprises once every two minutes; once an hour; once a day; once a week; at the end of a journey; or after a predetermined distance traveled.

In one embodiment of the invention a vehicle charging device is provided. The vehicle charging device comprising a vehicle charging processor for receiving and processing location data indicating a location of a vehicle comprising a vehicle monitoring device during a journey between an origin point and a destination point, and emission data indicating an amount of emission produced by the vehicle during the journey from the vehicle monitoring device; and a road fee calculator for calculating a fee associated with the at least one vehicle monitoring device based on the received data.

In another embodiment the vehicle charging device further comprises: a received data storage device for storing the received data.

In another embodiment the GPS data further indicates time and date data associated with the journey.

In another embodiment the vehicle charging device further comprises: a vehicle attribute storage device for storing attribute data about a vehicle comprising the at least one vehicle monitoring device.

In another embodiment the vehicle attribute data comprises at least one of: type of vehicle; make of vehicle; model of vehicle; engine size; fuel type; vehicle age; manufacturer predicted fuel consumption data; manufacturer predicted emission data.

In another embodiment the road fee calculator calculates the fee associated with the at least one vehicle monitoring device based on the received data and the attribute data.

In another embodiment the fee may be a credit or a debit.

In another embodiment the vehicle charging processor is capable of receiving an unique driver identifier from the at least one vehicle monitoring device.

In another embodiment the vehicle charging processor is capable of receiving an unique vehicle identifier from the at least one vehicle monitoring device.

In another embodiment the vehicle charging device further comprises: a road fee database for storing road fee data associated with road sections, and wherein the road pricing fee calculator calculates the fee associated with the at least one vehicle monitoring device based on the received data and the road fee data.

In another embodiment the vehicle charging device further comprises: a road toll storage device for storing toll fee data associated with road tolls.

In another embodiment the vehicle charging processor is capable of receiving road toll data from the at least one vehicle monitoring device, and wherein the road fee calculator calculates the fee associated with the at least one vehicle monitoring device based on the road toll data and the toll fee data.

In another embodiment the vehicle charging device further comprises: a communication device for enabling two way communication between the vehicle charging device and the vehicle monitoring device, and wherein the vehicle charging device provides fee data to the vehicle monitoring device.

In another embodiment the vehicle charging device further comprises: a registration device for registering a driver with the vehicle charging device.

In another embodiment the vehicle charging device further comprises: a registration device for registering the vehicle with the vehicle charging device.

In another embodiment the vehicle charging device further comprises: a validation device.

In another embodiment the validation device comprises a map matching device, and wherein the location data is compared with map data stored in the map matching device to determine road sections traveled by the vehicle during the journey.

In another embodiment the validation device compares road toll data with data received from road tolls.

In another embodiment the validation device compares the emission data with vehicle manufacture emission data stored at the vehicle attribute storage device.

In another embodiment the validation device compares the emission data with historical emission data stored in the received data storage device.

In another embodiment the vehicle charging device further comprises: a historical road data storage device comprising historical data regarding a plurality of roads.

In another embodiment the vehicle charging device further comprises: a tamper detection device for determining whether the received data has been tampered with.

In another embodiment the tamper detection device compares the received data with historical received data.

In another embodiment the tamper detection device compares the received data from the vehicle monitoring device with received data from another vehicle monitoring device.

In another embodiment the tamper detection device compares the data received from the at least one vehicle monitoring device with third party data.

In another embodiment the third party data comprises at least one of average speed data, and/or traffic event data.

In another embodiment the vehicle charging device further comprises: an invoicing unit for receiving the calculated fee associated with the at least one vehicle monitoring device from the road pricing fee calculator, and for invoicing a driver of the vehicle.

In another embodiment the vehicle charging processor receives the data from the at least one vehicle monitoring device at predetermined intervals.

In another embodiment the vehicle charging processor requests the data from vehicle monitoring device at predetermined intervals.

In another embodiment the predetermined intervals comprises once every two minutes; once an hour; once a day; once a week; at the end of a journey; or after a predetermined distance traveled.

In one embodiment of the invention a road pricing apparatus is provided. The road pricing apparatus comprising: a plurality of vehicle monitoring devices as described above; and at least one vehicle charging device as described above.

In one embodiment of the invention a method of determining a road usage fee is provided. The method of determining a road usage fee comprising: receiving vehicle data from a vehicle monitoring device; determining distance traveled and road section traveled by a vehicle comprising the vehicle monitoring device during a journey, time and date of the journey, and fuel consumed during the journey based on the vehicle data; and calculating a road usage fee for the journey.

In another embodiment the method further comprises: invoicing a driver of the vehicle the road usage fee.

In another embodiment the method further comprises: determining an amount of emission during the journey based on the vehicle data.

In another embodiment the method further comprises: comparing the received vehicle data with vehicle data received from another vehicle; and determining whether the received vehicle data is correct based on the comparison.

In another embodiment the method further comprises: comparing the received vehicle data with third party data; and determining whether the received vehicle data is correct based on the comparison.

In another embodiment the third party data comprises data regarding traffic events.

In another embodiment the third party data comprises data regarding average speed of vehicles on a known road at a known time and date.

In another embodiment the method further comprises: storing vehicle attribute data about the vehicle in a storage device; and using the vehicle attribute data to calculate the road usage fee for the journey.

In another embodiment the vehicle attribute data comprises: the type of vehicle; the make of vehicle; model of vehicle; engine size; fuel type; the vehicle age; manufacture predicted fuel consumption data; manufacturer predicted emission data.

In another embodiment the method further comprises: comparing the received vehicle data with expected vehicle data; and determining whether the received vehicle data has been tampered with.

In another embodiment the expected vehicle data is determined based on historical vehicle data.

In another embodiment the received vehicle data comprises location data and distance traveled data, and wherein the method further comprises: comparing the location data with the distance traveled data; and determining whether the received vehicle data has been tampered with.

In another embodiment the received vehicle data comprises location data, and wherein the method further comprises: comparing the location data with map data stored in a map matching device; and determining road sections traveled during the journey.

In another embodiment the method further comprises: comparing time and/or date data received from a road toll device with time and/or date data received from a road toll.

In another embodiment the method further comprises: comparing the fuel consumption data with vehicle manufacture fuel consumption data.

In another embodiment the method further comprises: comparing the fuel consumption data with historical fuel consumption data.

In another embodiment the method further comprises: comparing the emission data with vehicle manufacture emission data.

In another embodiment the method further comprises: comparing the emission data with historical emission data.

In one embodiment of the invention a method of determining a road usage fee is provided. The method of determining a road usage fee comprising: receiving vehicle data from a vehicle monitoring device; determining distance traveled and road section traveled by a vehicle comprising the vehicle monitoring device during a journey, time and date of the journey, and an amount of emission during the journey based on the vehicle data; and calculating a road usage fee for the journey.

In another embodiment the method further comprises: invoicing a driver of the vehicle the road usage fee.

In another embodiment the method further comprises: comparing the received vehicle data with vehicle data received from another vehicle; and determining whether the received vehicle data is correct based on the comparison.

In another embodiment the method further comprises: comparing the received vehicle data with third party data; and determining whether the received vehicle data is correct based on the comparison.

In another embodiment the third party data comprises data regarding traffic events.

In another embodiment the third party data comprises data regarding average speed of vehicles on a known road at a known time and date.

In another embodiment the method further comprises: storing vehicle attribute data about the vehicle in a storage device; and using the vehicle attribute data to calculate the road usage fee for the journey.

In another embodiment the vehicle attribute data comprises: the type of vehicle; the make of vehicle; model of vehicle; engine size; fuel type; the vehicle age; manufacture predicted fuel consumption data; manufacturer predicted emission data.

In another embodiment the method further comprises: comparing the received vehicle data with expected vehicle data; and determining whether the received vehicle data has been tampered with.

In another embodiment the expected vehicle data is determined based on historical vehicle data.

In another embodiment the received vehicle data comprises location data and distance traveled data, and wherein the method further comprises: comparing the location data with the distance traveled data; and determining whether the received vehicle data has been tampered with.

In another embodiment the received vehicle data comprises location data, and wherein the method further comprises: comparing the location data with map data stored in a map matching device; and determining road sections traveled during the journey.

In another embodiment the method further comprises: comparing time and/or date data received from a road toll device with time and/or date data received from a road toll.

In another embodiment the method further comprises: comparing the emission data with vehicle manufacture emission data.

In another embodiment the method further comprises: comparing the emission data with historical emission data.

In one embodiment of the invention a method of determining a road usage fee is provided. The method of determining a road usage fee comprising: determining a debit based on roads used at a time of day; determining a credit or debit based on fuel consumed as a result of fuel tax already paid; determining a credit or debit based on low emission levels, when compared with manufactures stated levels of emissions for the vehicle; determining a creditor debit based on low mileage over a predetermined period of time as a result of road tax already paid; and determining a credit or debit for using roads at off peak times.

### DESCRIPTION OF THE DRAWINGS

For a better understanding of the invention and how the same may be carried into effect reference will now be made, by way of example only, to the accompanying drawings, in which:

FIG. 1 illustrates an outline schematic of the invention;

FIG. 2 illustrates a vehicle owner and driver registration process;

FIG. 3 illustrates a process and method to register a single journey;

FIG. 4 illustrates a data transfer process and method during a journey;

FIG. 5 illustrates a closedown of the data transfer from the vehicle;

FIG. 6 illustrates schematically a road network;

FIG. 7 illustrates a communication links between the vehicle and the IMS;

FIG. 8 illustrates further developments of the links between the vehicle and the IMS;

FIG. 9 illustrates a tamper detection and validation methods and processes;

FIG. 10 illustrates a link between data from the vehicle and any road pricing calculation;

FIG. 11 illustrates example data on a road length held on a digital map;

FIG. 12 illustrates a road user charging database;

FIG. 13 illustrates different types of fuel duty payable in the UK; and

FIG. 14 illustrates example data in a supplementary charges database.

### DETAILED DESCRIPTION

Additional advantages and novel features of the invention will be set forth in part in the description which follows, and in part will become apparent to those skilled in the art upon examination of the following and accompanying drawings or may be learned by practice of the invention.

In one embodiment of the invention a road charging scheme is provided which calculates a road user fee based on a combination of the time period during which the user was travelling, the distance traveled on each journey, the actual road traveled and the amount of fuel consumed during the journey and/or the amount of emissions during the journey.

The road pricing scheme of the invention comprises an On-Board Vehicle Monitoring Device (OBD) including Vehicle Data Collection Devices (VDCD) such as a GPS receiver, a Fuel Consumption Device (FCD) and/or an Emission Measurement Device (EMD). In one embodiment, the OBD tracks each journey by means of the GPS receiver and records the longitude and latitude of a vehicle provided with the OBD at defined time intervals (say every two minutes). The OBD then sends both the longitude and latitude data and time data to an Independent Monitoring Service (IMS) (Vehicle Charging Device). The IMS can use Digital Mapping (DM) to determine the roads upon which the journey was taken, on what day and at what time. The IMS then generates a fee for the journey based upon the combination of the time period during which the user was travelling, the distance traveled on the journey, the actual roads traveled upon, the fuel consumed during the journey and/or the amount of emissions during the journey.

The term journey is used throughout this application to define a trip made between an origin point and a destination point.

Although a GPS receiver is discussed above, any equivalent means may be used, for example any other satellite based location system, any terrestrial based triangulation system, and any cellular or similar location system could be used to determine the location of a vehicle provided with an OBD.

In another embodiment the OBD may use Digital Mapping (DM) to determine the roads upon which the journey was taken, and the OBD then sends the roads used data and time data to the Independent Monitoring Service (IMS) (Vehicle Charging Device).

Consequently, the road pricing scheme of the invention can be used to generate road user charges based upon the day and time of the journey (where, for example, travel at peak times may incur a greater charge than at off peak times), the type of road used (where, for example, motorway use incurs a greater charge than rural road use). In addition, the road pricing scheme of the invention can be used to generate road user charges based on the amount of fuel consumed (where for example, fuel efficient cars incur a smaller charge, or a rebate is provided as a consequence of already paid fuel duty) and/or the determined emissions (where for example, cars which provide less emissions incur a smaller charge).

Furthermore, the road pricing scheme of the invention can be used to generate road user charges based upon the vehicle used (where motorbikes may be charged less than medium sized vans).

In another embodiment the road pricing scheme of the invention can be used to generate variable road user charges based upon the day and time (for example currently congested areas may incur higher charges than at uncongested times, or inner London on weekdays at peak times incurs a higher charge than non-peak time or evenings). The variable charges may be used to, deter congestion, by raising prices to a level at which traffic flow is locally acceptable.

In one embodiment the IMS offers their users warnings, by means of the OBD, of charges upon roads upon which they are either travelling or about to travel. These charges could be obtained from a database held by the IMS. This provides users the ability to choose routes based upon potential road user charges to be incurred.

In a similar manner Pre-Journey Planning Information (PJPI) could be used to calculate a route with a given start time from an Origin to a Destination (OD) based upon minimising any potential road user charges. In addition a route could be calculated between an Origin and a Destination, and suggest a start time which reduces the road user charges.

In addition the road pricing scheme of the invention offers a single scheme which can cover the requirements of all the above described road charging schemes. By means of a registration process at the IMS any ‘blanket charging’ issues can be incorporated; ‘closed tolling’, ‘point charging’, ‘area charging’ and ‘penalty systems’ issues can be determined by the IMS from the location and timing data collected, and ‘distance based’ charging can be incorporated in the scheme.

In another embodiment data collected by the OBU (at a single point) may be validated at the IMS by data from third-party sources.

However, a road pricing scheme can only be a national road pricing scheme and/or replace existing schemes if all vehicles are included. This is a particularly impossible task since, for example, a substantial number of vehicles from overseas use UK roads. However, a local, voluntary or road pricing scheme for alternative types of vehicles (for example, HGV's) would enable the IMS to undertake collection of fees for existing and new road charging locations using other methods. If an IMS undertook collection for and on behalf of other road charging enterprises they may be able to negotiate a discounted fee and be able to offer their customers a commercial benefit and an incentive to join a voluntary IMS.

In the one embodiment of the invention the OBD could by means of a VDCD collect data about a vehicles operating characteristics, such as but not limited to, fuel usage (by a FMD) and emissions (by a EMD). If these devices were professionally fitted and calibrated, by approved organisations, they could be used to collect data which could either verify any expenditure or be compared to statistics offered by the manufacturers or independent testers and credits offered where positive improvements are proved. Thus in its simplest form a FMD will confirm fuel used upon which a credit offset may be raised against any road user charging incurred. In a more complex form a vehicle mounted EMD may provide a low emission reading and/or an emission reading lower than the one quoted by the vehicle manufacturers (which may imply careful driving) and could lead to monthly or quarterly credit against any road user charges.

Thus a motorist who drives particularly carefully in a vehicle with low emissions only in off peak times for short distances on rural roads may receive a substantial credit (to offset their fuel and other costs). Whereas a motorist who drives erratically in a large car with high emissions mainly at peak travel times for long distances and in the congested urban environment would not earn any credits. Therefore the road pricing scheme could have the effect of an equitable tax scheme where charges would be based upon type of vehicle, time of travel, distance traveled, location of travel and fuel used and/or emission levels.

The invention provides a road pricing scheme for a vehicle which based upon a multitude of parameters calculates the fee for use of the road/road section or accumulates these charges over a period, and determines any credits for such factors as low mileage driven (and thus low fuel consumed) or low emissions levels.

Throughout this application a vehicle may be any motorised unit using fuel such as a motorbike, a car, a van or a heavy goods vehicle. However, this list is for illustrative purposes only and the invention is not limited to only these types of vehicle.

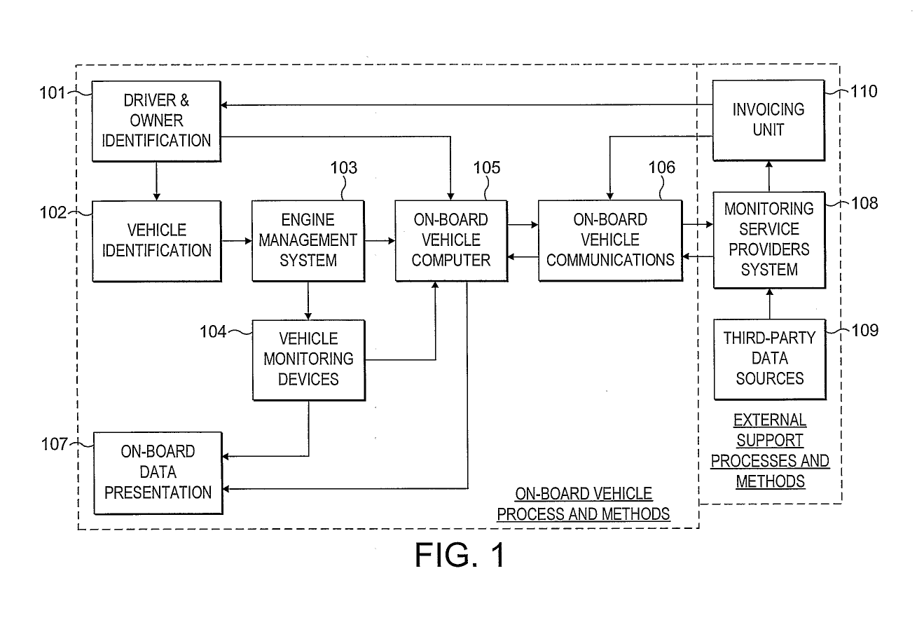

FIG. 1 illustrates an outline schematic of the invention. In this embodiment of the invention there are two distinct elements which are integrated to complete the invention; firstly, the on-board vehicle processes and methods for one and many vehicles; and secondly, the external support processes and methods from a single IMS unit for many vehicles.

In one embodiment, before a journey begins, the vehicle owner registers both the vehicle and the driver (101) with the IMS and obtains a registered driver's identity. When the driver offers this identity to the on-board vehicle (VMD) computer (105), the IMS (108) verifies both the vehicle identity (102) and the driver identity (101). The verification process activates the link between the on-board vehicle computer (105) and both the engine management system (103) and the vehicle data collection devices (104).

In another embodiment the OBD is registered with the IMS (108) once and does not need to be registered before each journey. The OBD may be registered with the IMA at the point of manufacture and/or installation. Furthermore, in another embodiment, the driver does not need to register with the IMS. In another embodiment vehicle registration is automatic upon ignition of the engine.

Throughout the journey the on-board vehicle computer (105) collects data from the vehicle data collection devices (104) and passes this back to the IMS (108) through the on-board vehicle communications links (106). Such data, would for example include but not be limited to, the vehicle location data collected by the on-board GPS receiver or a similar device, which would be one of the vehicle data collection devices (104). Throughout the journey the IMS (108) would feed selected data back to the vehicle from a data base to an on-board data presentation (107). Such data could include current position data (section on the road network), the road pricing band for the road section and the fee at that time of day for that road section on the road network. The on-board presentation device could be a digital display device (DDD) and on some vehicles an existing DDD such as the navigation system or radio may be used.

At the end of the journey the driver can remove their registered identity (101) (if applicable) and the on-board computer (105) closes down the engine management system (103) and the vehicle monitoring devices (104). The IMS (108) could then verify random acts on the journey from data obtained from third-party sources (109). Such data, could for example include but not be limited to, checking the average vehicle speed on a road section either with that of other motorists or with data available from other sources in the market for that day and time. Following verification of the journey the IMS (108) could pass any charges incurred to an invoicing unit (110). By similar means the IMS (108) could monitor such data as total mileage driven, fuel consumed and/or emissions levels, calculate whether any credit was due, and pass this information to the invoicing unit (110). The invoicing unit (110) could charge the vehicle owner or driver (101) on a regular basis and either collect any moneys due or repay any credits due.

Although FIG. 1 indicates there is only one vehicle and driver being monitored, in the embodiments of the invention there could be a plurality of vehicles, all of which could be monitored by two way communications with the IMS (108). Furthermore, in the embodiment of the invention there may be more than one IMS.

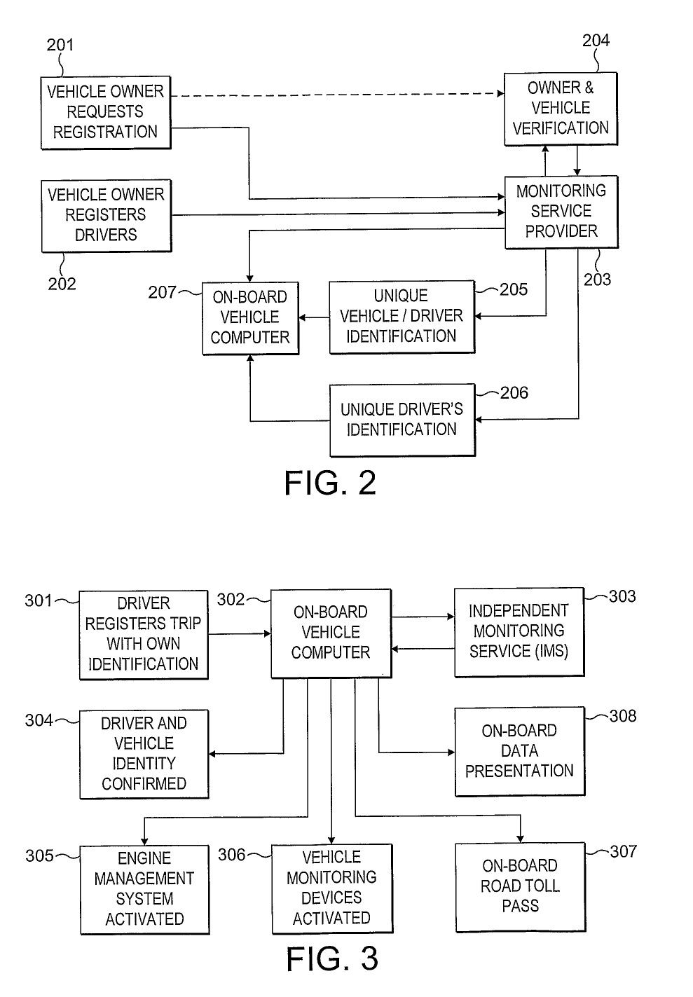

FIG. 2 illustrates the vehicle and/or vehicle driver's registration process and method with the IMS. In this embodiment, the vehicle owner (201) requests, a unique vehicle identity (205) from the IMS (203) who may verify vehicle details (204) with relevant authorities such as the DVLA in the UK. Because there may be more than one driver for each vehicle, the vehicle owner (201) can also register each potential driver (202) and obtain a unique driver identification (206) from the IMS (203) for each driver. Each unique driver identification (206) may be registered both against a number of vehicles and a number of IMS providers. This unique driver identity could for example include but not be limited to, a personal identification number (PIN), a magnetic card, an electronic key fob or any method to input a personal number to the on-board computer. The IMS (203) can pass both the vehicle identity and relevant driver identities to the on-board vehicle computer (207) for storage and independent verification thereafter. In one, embodiment, for security reasons the IMS can require both the vehicle and driver to be re-registered at regular time intervals.

In one embodiment an initial registration process can be used to log the vehicle attributes, such as but not limited to, the type of vehicle (motorbike, car, van, HGV), make of vehicle (BMW, Ford, MAN, Saab, Scania), model of vehicle (saloon or estate), engine size (1.6, 2.3 litre), fuel type (diesel, LPG, petrol), date of manufacture and registration number. Further characteristics used to recognise a vehicle such as engine number, chassis number and security numbers etched into the windows may also be recorded. This data could be input to the IMS computer and potentially used to verify the vehicle by the IMS. In one embodiment, the attribute data is transferred to the IMS upon installation of the OBD to a vehicle.

In another embodiment owners may register vehicles which are exempt from road user charges (for example ambulances and other public service ice vehicles) but require the IMS to track and record the vehicles for operational purposes.

The registration process for both the owner and any driver can include their agreement (in writing) for the use of any data collected by the IMS in order to avoid any issues related to, for example, the UK Data Protection Act 1998. In another embodiment, for example, in the UK any initial registration data may be validated by data held at the Driver and Vehicle Licensing Agency (DVLA).

FIG. 3 illustrates the process and method to register a single journey according to one embodiment of the invention. Initially the driver registers a journey with their own PIN (301) with the IMS (303) by means of the on-board vehicle monitoring computer (302). The IMS (303) confirms recognition of vehicle and driver (304) by means of the on-board presentation (308). The on-board vehicle computer can then activate the engine management system (305) and the vehicle data collection devices (306). The onboard computer can also activate the on-board road toll device (307).

In another embodiment, if the driver fails to register with the IMS, then the journey may be made and the on-board data presentation can indicate that the engine management system (305), the vehicle data collection devices (306) and the on-board road toll device (307) are inactive for the purpose of road user charging. This means that the driver may have to pay any road pricing or toll fees in any alternative manner prescribed.

The on-board road toll device (307) is a device which, in one embodiment may send out a signal to a road toll booth, such that the road toll booth barrier, in so far as a barrier exits, is lifted enabling the vehicle to pass through the road toll booth without making a payment at that point. The road toll booth identifies the on-board road toll device and the IMS registers (in one embodiment, by means of the GPS signals) a payment to the road toll booth. Payment may take several forms including but not limited to pre-payment or post payment methods which allows the vehicle to pass through the road toll booth and not to stop and pay, thus avoiding any bottlenecks or traffic queues.

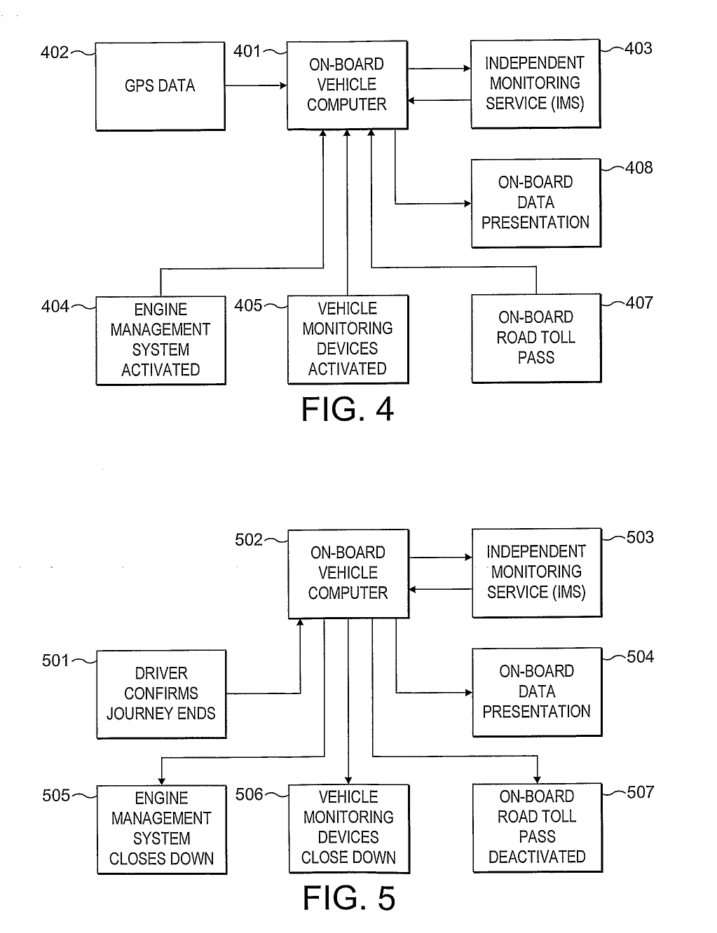

FIG. 4 illustrates a data transfer process and method during a journey. In one embodiment, the on-board vehicle monitoring computer (401) communicates to and from the IMS (403) by means of the on-board vehicle communication system (106). This on-board vehicle communication system, could for example include but not be limited to, the General Packet Radio System (GPRS), the Short Messaging System (SMS) or 3G wireless systems. The on-board vehicle computer initially stores GPS data (402), engine management system data (404), vehicle data collection device data (405) and on-board road toll device data (407) at preset intervals (say every two minutes although the time intervals may be user defined) then throughout the journey passes this as data to the IMS (403).

The on-board vehicle monitoring computer (401) is capable of two way communications with the GPS unit (402), the engine management system (404), the vehicle data collection device (405), the on-board road toll device (407) and the on-board data presentation unit, by means which could, for example include but not be limited to, be direct by wire through a local area networks or indirectly by a local wireless network or other similar methods known in the art. The on-board data presentation unit is also capable of ‘touch screen’ data input, by methods known in the art.

The GPS monitoring device (402) determines the position of the vehicle throughout its journey, by methods known in the art. In one embodiment the GPS device determines the vehicle location in terms of its latitude and longitude by means of a multiple of satellite readings and records the time at which the vehicle is at that position and continues to take such records at preset intervals (say every two minutes) to record the whole journey. The GPS device may also comprise an odometer, a gyroscope, and wheel sensors which receive data either from the gearbox or the wheels of the vehicle, as known in the art. Such devices enable the position of the vehicle to be determined if the satellite signals are temporarily lost, such as when the vehicle is travelling through a tunnel. The GPS unit may store and transfer data to the on-board vehicle monitoring computer either periodically or in real time as data is collected. In addition to those communications systems cited, stored GPS data may also be downloaded by ‘radio data download’ by methods known in the art.

It is practical to obtain non-GPS derived distance traveled from the vehicle gearbox and engine management system (404) which records the vehicle mileage traveled. These alternative methods for vehicle mileage recording are known in the art.

The engine management system (404) directly monitors many vehicle engine characteristics, one such example being the monitoring of engine revolutions which may be compared with speed to determine whether the correct gear is used or whether the engine has excess revolutions while idling (not in gear or not moving). The data is collected directly by sensors on various parts of the engine and transferred to the on-board vehicle computer (401) by means of a controller area network (CANBUS). The majority of vehicles manufactured since the mid 1980's have a CANBUS fitted, although different manufacturers have different versions and may monitor different engine features. However, if it is known which CANBUS is fitted (manufacturer and version) then it, is possible to extract the required data and transfer it to the on-board vehicle monitoring computer.

Although some engine management systems record fuel usage such recordings are relatively inaccurate over a short journey and not relevant for this invention. To correct such issues in one embodiment of the invention separate vehicle data collection devices (405) are used to obtain an accurate fuel use reading and an accurate determination of emissions.

The emissions measured by the separate vehicle data collection device (405) may be any vehicle emission which are required, such as carbon emissions, nitrogen dioxide emissions, or sulphur dioxide emission to name but a few.

One vehicle data collection device designed to accurately determine fuel use is known as a ‘flow meter’. The flow meter is a fluid measuring device which is located between the on-board fuel storage tank and the fuel pump which pumps fuel to the engine and therefore accurately measures the fuel usage even on short journeys. The flow meter measures the flow of fuel by means of ‘pulses’ as a given quantity of fuel passes through the pump over short time intervals. The flow meter provides a KMS output in terms high and low and the frequency is measured to provide fuel flow volumes in litres per hour by communicating the results either to the engine management system (CANBUS: can-high and can-low) or the on-board vehicle monitoring computer. Accurate measurement is achieved by counting each pulse where a pulse represents a defined volume of fuel, typically, one tenth of a litre.

Alternatively a fuel pump which records fuel flow and feeds the data direct to the CANBUS could be used. Fuel pumps measure fuel with 10 pulses, nine pulses of say one tenth of a litre then a tenth pulse of the same measurement which sends a signal to the CANBUS enabling a calculation of distance (kilometres) per litre of fuel. The accuracy of these calculations is limited to the last full litre of fuel used. Furthermore, when the engine is turned off the fuel flow data is stopped and may be lost, and the data will start recording again at zero when the engine is restarted. However, fuel pumps are known which offer greater accuracy because they are able to transfer data at each pulse (typically, one tenth of a litre) to the CANBUS and they provide data which is as accurate as a fuel flow meter.

These two examples are used to illustrate different vehicle data collection devices however, other fuel consumption device which are not detailed could be used

The use of fuel is accurately calculated from any measurement device (fuel flow meter or fuel pump) which is situated directly before the vehicle engine. The concept of monitoring fuel into a vehicle tank cannot represent a real measurement because fuel evaporates in the vehicle tank, fuel may (in the case of Heavy Goods Vehicle (HGV) or plant vehicles) be used to drive a Power Take Off (PTO) for ancillary equipment on the vehicle (for example a compactor on a refuse vehicle) and fuel may be siphoned from a vehicle fuel tank. It is deemed that collecting data on fuel input to a vehicle fuel tank is potentially too inaccurate and liable to many errors.

In a further embodiment of the invention a vehicle data collection device for determining emissions may be provided. The emissions data collection device is fitted to the exhaust outlets on the vehicle. In one embodiment a carbon sensor is used to determine the maximum number of carbon particles in the exhaust gases and readings may be taken at specific time intervals. These readings may either be taken upon the exhaust gasses alone and/or the air surrounding the vehicle. Such readings may be transferred directly from the carbon sensor to either the engine management system or the on-board vehicle monitoring computer and presented as either a maximum carbon reading for a journey or an average carbon reading over a period of time.

In one embodiment of the invention the on-board vehicle monitoring computer (401) requests data from the engine management system (404), the vehicle data collection devices (405) and the on-board road toll device (407). Such data may be requested (which is known as polling) at pre-determined intervals such as after each journey, once a day, once a week or after a predetermined distance traveled. Similarly, the IMS (403) may request (poll) the on-board vehicle monitoring computer (401) for such data at predetermined intervals.

In another embodiment of the invention the engine management system (404), the vehicle data collection devices (405) and the on-board road toll device (407) automatically transfer data to the on-board vehicle monitoring computer (401) periodically such as after each journey, once a day, once a week, after a predetermined distance traveled or at any alternative prescribed interval. Alternatively, such data may be transferred in real time throughout a journey. Similarly the IMS (403) may obtain data from the on-board vehicle monitoring computer in real time throughout a journey.

In a further embodiment of the invention the on-board vehicle computer (401) may request data from the GPS data unit (402), the engine management system (404), the vehicle monitoring devices (405) and the on-board road toll pass (407) for a specific period of time (day and time) such as Monday between 0700 hrs and 1000 hrs.

In one embodiment of the invention the apparatus for the on-board vehicle processes and methods, including but not limited to, the on-board vehicle computer (401), the GPS data unit (402), the engine management system (404), the vehicle monitoring devices (405) and the on-board road toll pass (407) are capable of being fitted to any vehicle, the user of which has elected to be a member of a road pricing scheme. However, in an alternative embodiment such apparatus for the on-board vehicle processes and methods (described above) could be provided in whole, or in part, integrally with the vehicle during the manufacture of the vehicle.

FIG. 5 illustrates the closedown of the data transfer from the vehicle. The driver confirms that the journey ends (501) either by withdrawing their personal identification in what ever form or by turning off the vehicle. The on-board vehicle monitoring computer (502) will recognise closedown and send the closedown message to the IMS (503) and the on-board data presentation (504). The on-board vehicle monitoring computer will also send an instruction to the engine management system (505), the vehicle data collection devices (506) and the on-board road toll device (507) to closedown.

In another embodiment of the invention a tamper detection device (not illustrated) may be fitted to the vehicle to determine whether the GPS device (801), the engine management system (802), the vehicle data collection devices (803) and the on-board road toll device (804) are working properly and/or whether the data has been interfered with. The tamper detection device compares data transfers between each of the on-board vehicle processes and methods with an expected data stream and in the event of any unusual data streams sends a message to both the IMS via the on-board vehicle monitoring computer and the on-board vehicle communications system and the driver via the on-board presentation unit. The tamper detection device may also send an audible signal of a fault found. Once the tamper detection device has triggered a fault the IMS ignores all data on that and other journeys until the IMS has reset the tamper detection device by means of the two way communication system from the IMS to the on-board vehicle monitoring computer. The message to the driver may be suppressed, if for example, the vehicle has been started without a key (or alternative means provided by the vehicle manufacturer) and a warning message is sent to a pre-designated vehicle security operation.

A known tamper detection device is provided in the NavTrak™ on-board vehicle monitoring device which has a number of tamper detection and fault warning modes. In addition the NavTrak™ system includes an automatic driver recognition card that is carried separately from the ignition keys by the driver and communicates with the NavTrak™ on-board vehicle unit. Therefore, even if an unauthorised driver has the vehicle ignition keys, unless the unauthorised driver has the NavTrak™ driver recognition card the system will send a silent alert to the NavTrak™ control centre. A plurality of tamper detection devices are available and this invention would be able to incorporate alternatives.

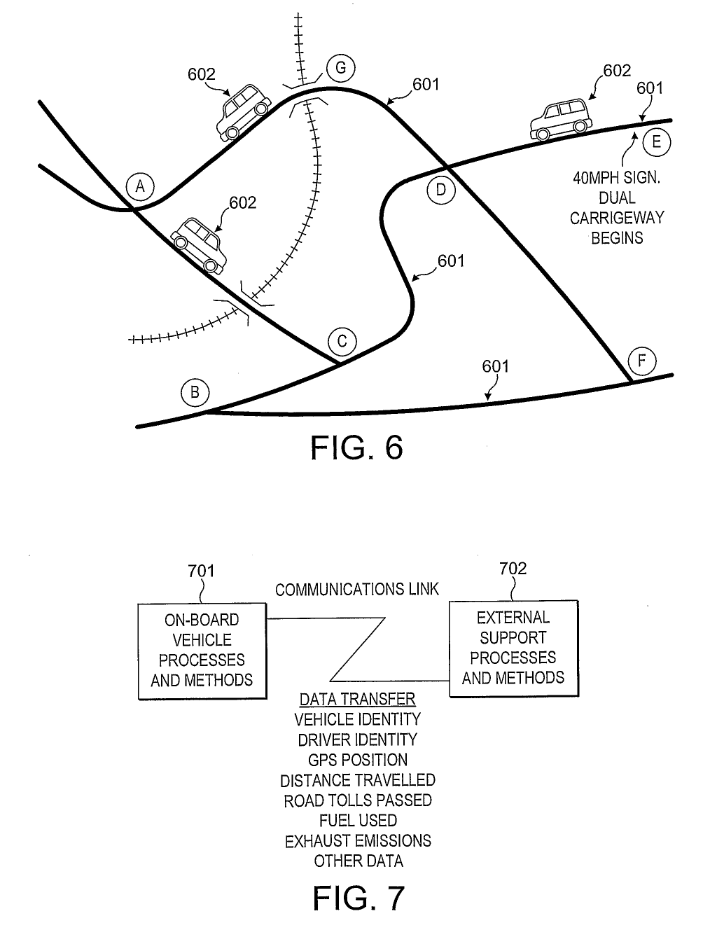

FIG. 6 schematically illustrates a road network comprising several roads (601) having a plurality of road lengths (sections) upon which a plurality of vehicles travel (602). A road length in one embodiment is formed between any road junction or road intersection, such as the road length formed between point A and point C; point B and point C; point C and point D; point A and point D; point D and point F and point B and point F. In addition, a road length may also be formed between any predefined points on that road; such as the road lengths formed between the intersection at D and the railway bridge at G, or the intersection at D and the beginning of the dual carriageway at E.

FIG. 7 illustrates the link between the on-board vehicle processes and methods and the external support processes and methods at the IMS. The on-board vehicle processes and methods (701) described above collect and transfer such data as the vehicle identity, driver identity, GPS position, distance traveled, road tolls passed, fuel used, exhaust emissions and other relevant data to the external support processes and methods (702). This communication link could be in real time using such means, but not limited to, wireless links such as SMS, GPRS, band 3, or local radio data download, or direct means such as data transfer by CD ROM or memory stick on to a PC for subsequent data transfer by modem, cable or alternative means.

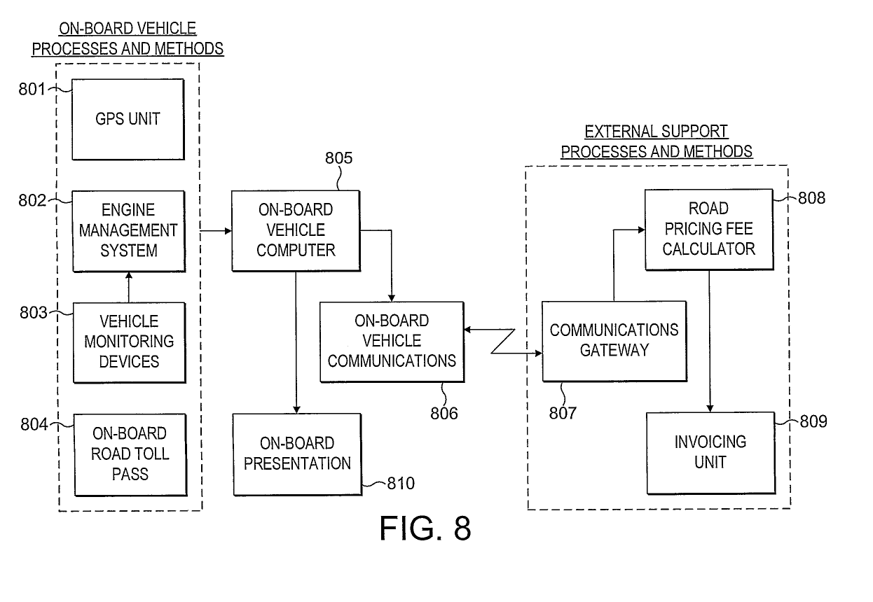

FIG. 8 illustrates further development of the links between the on-board vehicle processes and methods and the external support processes and methods at the IMS. In one embodiment of the invention the GPS device (801), the engine management system (802), the vehicle data collection devices (803), and the on-board road toll pass device send their data in real time direct to the on-board vehicle monitoring computer (805). The vehicle data collection devices (803) could either pass data directly to the on-board vehicle monitoring computer or indirectly by means of the CANBUS linked to the engine management system (802).

In another embodiment of the invention the on-board vehicle monitoring computer polls each of the devices at defined time intervals to collect new data. In another embodiment of the invention the on-board vehicle monitoring computer may collect data by a mixture of vehicle data collection devices passing data to the computer in real time and the computer polling the devices at set intervals for data downloads. The on-board vehicle monitoring computer stores data for a minimum period of three months or until the data is downloaded to an alternative data memory medium for transfer to the IMS.

In one embodiment, the on-board vehicle monitoring computer (805) uses the on-board vehicle communications system (806) to pass data to the external support processing system at the IMS through a communications gateway (807) to the road pricing fee calculator (808). In a similar manner to the on-board vehicle processing and methods these communications may be either real time data transfers or polled data transfers. At the IMS the road pricing fee calculator, will upon completion of the calculations for each journey, pass the results to the invoicing unit (809).

In a further embodiment of the invention the external support processes and methods employed at the IMS will feedback in real time from the road pricing calculator (808) via the communications gateway (807) and the on-board vehicle communications (806) to the on-board vehicle monitoring computer (805) and the on-board presentation (810), the current road description (from the mapping unit), the road pricing fee in place at that time and at the end of the journey a list of all the debits and credits incurred both on that journey and cumulatively within the current accounting period. Where an accounting period may be a number of days, a week, a calendar month or any other defined time period between which invoice statements are raised upon which payments or refunds are due. Two way communications between the vehicle and the IMS is required to support this process.

In another embodiment the road pricing calculator and a road pricing database may be provided in the OBD such that the OBD can determine the fee associated with each journey.

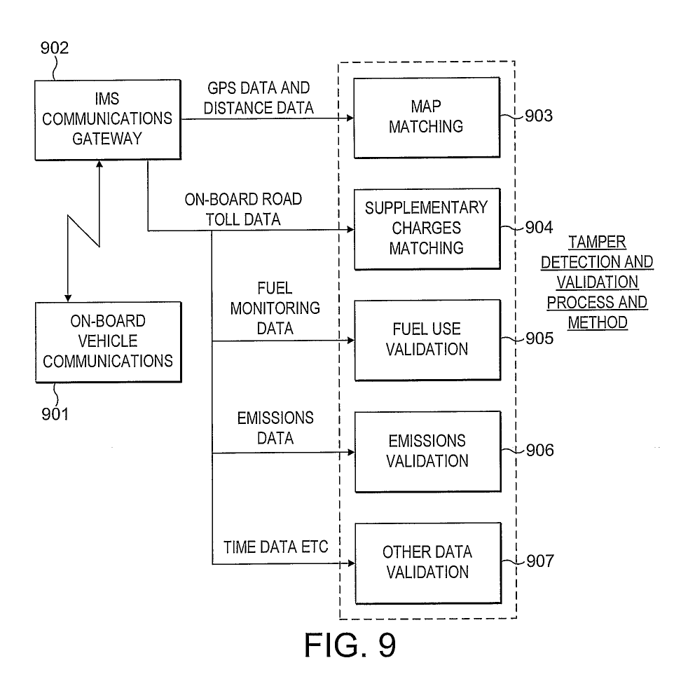

FIG. 9 illustrates the tamper detection and validation of data at the IMS. Each element of data required for the road pricing calculation which is taken from the on-board vehicle monitoring computer is validated by another calculation process and method. In the instance of the distance traveled calculation the on-board vehicle communications (901) sends to the IMS communications gateway (902) the GPS data (801) and this is matched to a digital map (903) by methods known in the art. It is, therefore, possible for the IMS to track the route of each vehicle, either in real time or from data transferred at a later date, on the map from the GPS data and calculate the distance traveled on each journey. Such a map matching calculation could be used to validate the distance traveled on each journey which is provided by the on-board vehicle computer. At present GPS data is only accurate to within 1 meter so where there are two roads where vehicles may travel in the same direction within 3 meters of each other additional validation data may be required to determine the road upon which the vehicle is travelling. This will be achieved by calculation of the average speed of the vehicle on the road length concerned compared with the forecast average speed for that particular road length on the day and time in question. The IMS may have a database of average speeds over each road length for each day and time, a known average road speed database for the UK is the Road Timetable™ determined by a method and process known in the art.

In a similar manner the GPS data could position a vehicle at a road toll, bridge or tunnel toll entrance and exit and when combined with a date/time stamp and the vehicle type from the on-board vehicle monitoring computer allow the calculation of a supplementary charge for road, bridge and tunnel tolls. This data could be validated by the data from the on-board road toll device (804) and/or data received from a road toll booth at the road toll.

Any road user charges or supplementary charges could be set by the responsible authority and the IMS or the OBD could update their data base with changes when informed by the authority of the date and time of any fee changes.

Again both fuel use data (905) and emissions data (906) provided by the vehicle' data collection devices (803) and the engine management system (802) and sent from the on-board vehicle monitoring computer (805) may be validated by the IMS by standard statistical techniques to determine unacceptable variances from both reference data provided by the vehicle manufacturer and by historical records from the vehicle in question.

The IMS may undertake a number of other validation routines, such as but not limited to, date and time checking between the on-board vehicle monitoring computer and the IMS computer and vehicle number plate recognition at the entrance or exit to road lengths, road tolls, bridges and tunnels.

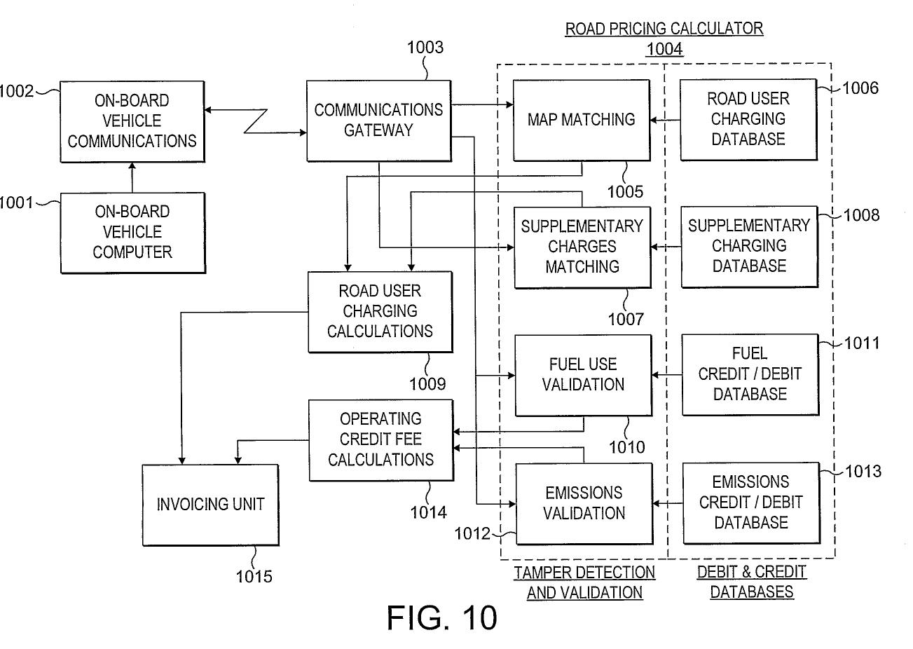

FIG. 10 illustrates, in one embodiment, the link between an individual vehicle and the road pricing calculations. The on-board vehicle monitoring computer (1001) passes data by means of the on-board vehicle communications (1002) through the IMS communications gateway (1003) to the Road Pricing Calculator (1004).

In one embodiment of the invention of the Road Pricing Calculator there is a method and process to determine any road user charges incurred (1009) by means of the combination of distance traveled over specific road lengths verified by map matching (1005) multiplied by any basic road user charges to be paid, which are held in a road user charges database (1006) whether provided in the IMS or the OBD; and any supplementary charges for specific road tolls (for example, bridges or tunnels) verified by the supplementary charge matching process (1007) from a supplementary charge database (1008). The use of a database allows the application of a plurality of fees or charging bands based upon, but not limited to; direction of travel, vehicle type, day of the week and time of day. Any private road, except those with a supplementary charge will not have a road length listed in the database.

For example, in one embodiment, the vehicle GPS data gives each road length (section) upon which the vehicle has traveled on a particular day and time, the distance traveled is validated by comparing the distance traveled recorded by the vehicle (CANBUS) and the map matched distance and the road tariff calculated for travelling on that road length on that day at that time. Thus a vehicle travelling from its origin to destination may traverse one or more road lengths incurring fees and the total fee charged would be the sum of these fees. The same vehicle may also collect additional fees in a similar manner on its return journey. This calculation itself could be validated, for example on a road length the charges would only be applied if a vehicle traveled a distance of more than 15% of the road length on any one journey for which a fee was payable. This would ensure that no charge was levied when a vehicle travelling on road lengths which did not warrant a fee crossed a road length which did warrant a fee.

In a similar manner if a vehicle stopped on a road length which warranted a fee and then restarted within the same or the next time zone a validation process could ensure that only a single road user charge fee was levied. The IMS could have a number of similar rules built into the operating software to ensure all the road user charging rules for each specific road length were both interpreted and charged correctly.

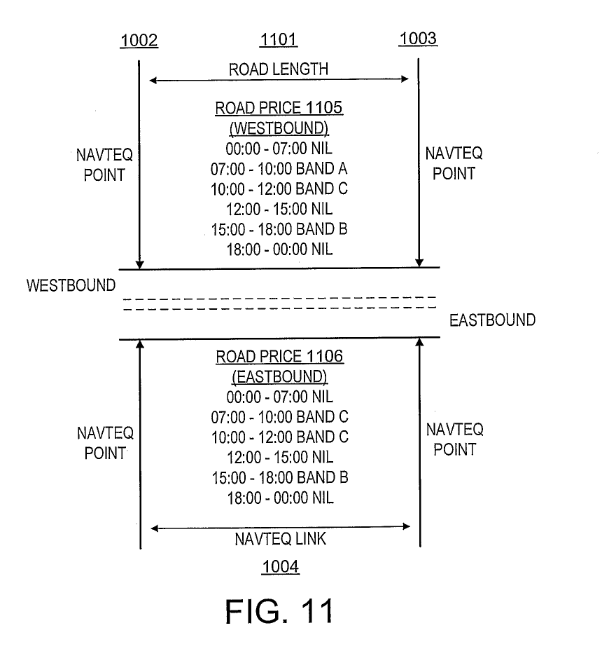

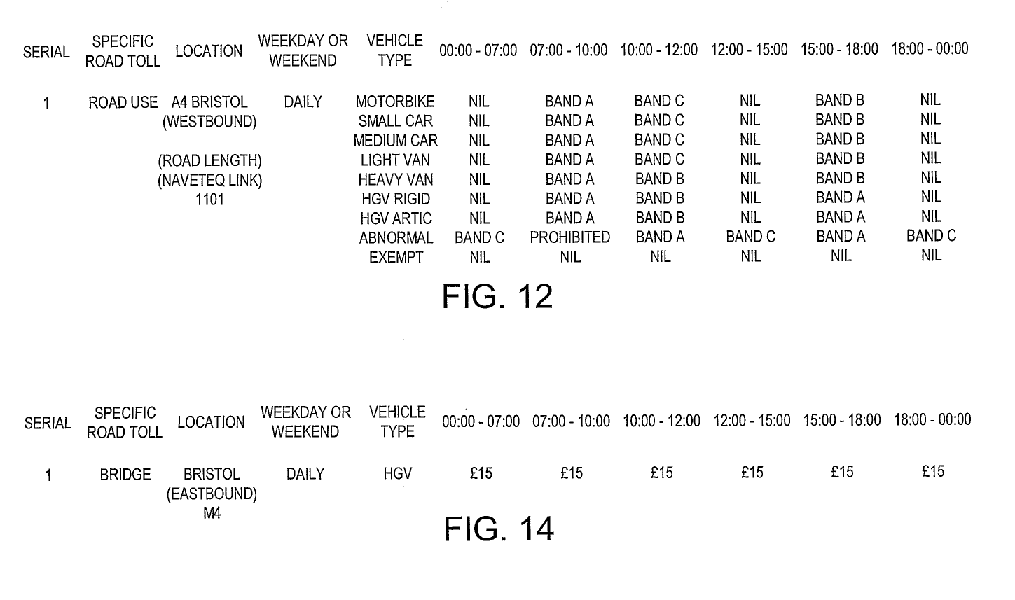

FIG. 11 illustrates example data on one road length on a digital map. Digital maps currently cover whole areas such as the UK, each European country and many other areas of the world. The digital map defines each road length (1101) from one point (1102) to another point (1003). The digital map also holds relevant data on the road network in separate road lengths (except minor roads) in the form of links between two points. The IMS can store a plurality of digital mapping data, one such being the Navteq map (which is a proprietary brand of digital map for many countries) has data on each road link (1004), such as but not limited to, distance between the points, any road features at or between the points, the speed restrictions between the points and any places or establishments of interest to the motorist. Typically any specific road toll or bridge toll would have a Navteq point at each end or entry and exit point. The road user charging database (1006) would be made up of road prices for time bands for each direction of travel (1105) and (1106). FIG. 12 illustrates the road user charges database.

The road charges can be altered as a result of the congestion level determined on each section of each road. For example, if a road accident results in a high level of congestions on a specific road, then the charges associated with the road section on which the accident occurred may be increased and at the same time, the road charges associated with the surrounding roads may be reduced.

In a further embodiment of the invention there is a method and process to calculate any operating credits due on a journey for fuel use or emissions both of which are designed to refund some element of tax paid on fuel purchased or road tax purchased based upon fuel use or emissions. In addition further operating credit may be given for various aspects of driving activities, such as but not limited to, a credit against the road fund licence for low mileage driven in any accounting period or, for example where over 90% of the total mileage driven in an accounting period was either on roads not incurring road user charges (the nil charge band) or where the use of the road network was outside peak travel times (the nil charge band).

In a further embodiment one or more operating characteristics may be combined to provide a credit for a payment made, for example, the combination of a low mileage driven in any accounting period and the use of roads with either a full nil charge band or during a time when the nil charge band was in force could lead to tax credit in that accounting period on fuel used for those journeys.

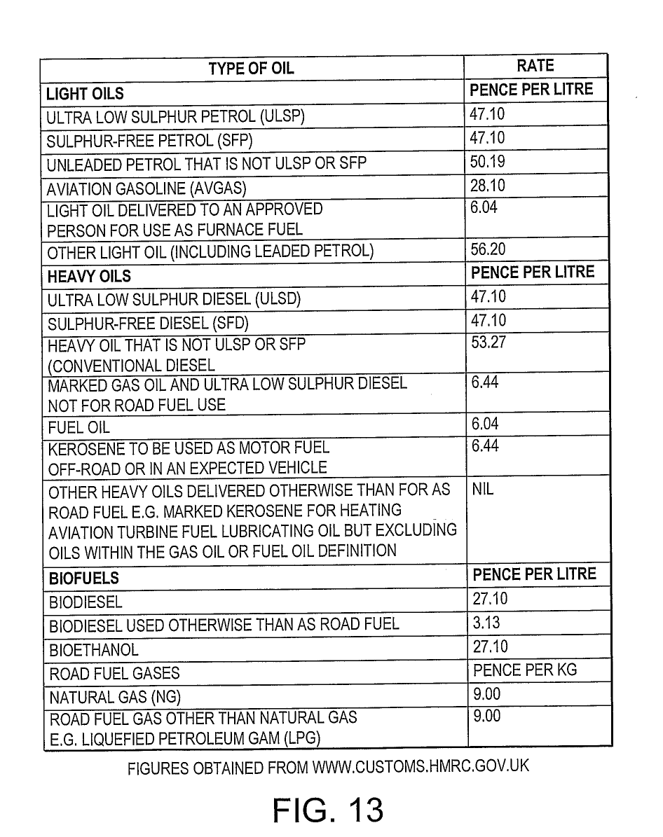

FIG. 13 illustrates the fuel duty payable (not including Value Added Tax) for a plurality of different fuels in the UK on 22 Nov. 2006. It is recognised that different vehicles use different fuel types (declared upon registration) and that any fuel use credit may differ by fuel used in the vehicle and type of vehicle used.

FIG. 14 illustrates example data on a supplementary charges database. The IMS includes a database which has relevant information on the fee structure wherever supplementary charges should be incurred such as road, bridge or tunnel tolls of any type. The map matching process for each registered vehicle journey undertaken by the IMS identifies whether a vehicle has traversed a boundary to incur a supplementary charge. The use of a database allows the application of a plurality of fees based upon, but not limited to; direction of travel, vehicle type, day of the week and time of day.

In one embodiment of this invention the charge is validated by the on-board road toll device (307) in the vehicle which detects a signal when the vehicle travels through a specific road toll. This on-board road toll device has a means of identification which allows the vehicle through and the road toll has a sensor to detect the registered vehicle. The requirement for payment by an individual vehicle (with a date and time reference) is known by the supplementary charging authority and payment from the IMS with reference to a specific vehicle date and time cancels any outstanding debt.

In another embodiment of the invention the IMS downloads a credit onto the individual vehicles on-board road toll device (at the request of the driver) and as the vehicle passes a sensor at the supplementary charge road toll the road toll device is debited for the relevant charge. Both the credit to the on-board road toll pass and any debit when the on-board road toll pass is charged are shown on the invoice statement for the accounting period.

In a further embodiment the IMS may, after negotiations with a specific road toll charging authority (for example, a specific tunnel charging authority), be able to offer discounted rates for regular (frequent) users.

In one embodiment, the IMS only undertake calculations and issue invoices where both the vehicle and driver are registered by the owner with the IMS and the specific journey registered by the driver by means of presenting their unique identity. In order to avoid duplication one vehicle may only be registered with one IMS but a driver may be registered with a plurality of IMS, this situation could be validated by each IMS submitting registrations to a common database agency which would check for duplication of vehicles.

The combination of debits from the road user charging calculations (1009) and the operating credit fees calculations (1014) could be invoiced in each accounting period by the IMS invoicing unit (1015) to either the vehicle owner or the driver as elected by the vehicle owner upon initial registration. However, in one embodiment, the initial agreement upon registration would place the responsibility for any debit payments upon the vehicle owner.

In one embodiment of the invention the driver would be able to access their account information, at any time during the accounting period, through the on-board presentation unit (107) using their PIN.

This invention, as described, offers a single time-distance-place (TDP) road user charging processes and methods and could be used to obtain payments in a number of forms, including but not limited to, blanket charging schemes, closed tolling, point charging, area pricing, distance based charging or penalty charging schemes. The current invention, as described, is more accurate than other known road pricing schemes because all factors in the calculations may be measured and validated against a second data source. In this invention the processes and methods use apparatus which include but are not limited to ones which are capable of monitoring the accurately mileage driven, the fuel consumption of the vehicle and the emission levels from the exhaust on each journey.

Furthermore, the TDP method could be used to offer incentives, in a form included but not limited to, either credits on fuel taxation in an accounting period for one or more of driving low mileages, driving on uncongested roads, driving out of peak hours; or a credit for driving in a manner which produced less emissions than the manufacturer's stated levels for the vehicle.

The TDP method of road user charging is equitable in so far as it only requires charges for costs as incurred and could offer credits for socially acceptable driving practices. The TDP scheme could be operated on a local (for example, Greater Manchester), an area (for example, the South West of England) or a national level. The TDP scheme could also be operated on a pilot, trial or voluntary basis.

The present invention offers the opportunity to overcome many of the current criticisms of existing road charging methods by offering a method and process which may be mileage related, avoid bottlenecks and queues at toll booths, minimise the burden of high capital expenditure by a single party and may be specific to a single or plurality of road lengths on any day and at any time.

In another embodiment of the invention the IMS, or an alternative organisation, may provide a journey planning cost optimiser and given a start time or arrival time recommend by means of a vehicle routing and scheduling algorithm the cheapest route from an origin to a destination or such similar information. This information may either be shown on the on-board presentation unit or by means of the website or SMS on the mobile phone or landline phone. In addition, the journey planning cost optimiser may suggest an alternative start time which would reduce the cost of the journey. In a further embodiment, the journey planning cost optimiser may suggest a route which would reduce the amount of fuel required for the journey, and/or reduce the amount of emissions per journey. Furthermore, the journey planning cost optimiser is capable of replanning a route during a journey in order to take account of unexpected events and maintain a low cost, fuel usage and/or emissions.

In another embodiment, the road charge may take account of whether alternative transport means are available.

Those skilled in the art will appreciate that while the foregoing has described what is considered to be the best mode and, where appropriate, other modes of performing the invention, the invention should not be limited to the specific configurations and methods disclosed in this description of the preferred embodiment. Those skilled in the art will recognise that the invention has a broad range of applications in road user charging and road pricing schemes, and that the embodiments may take a wide range of modifications without departing from the inventive concept as defined in the appended claims.

1. A vehicle monitoring device, comprising:
a location device for determining location data indicating a location of a vehicle during a journey between an origin point and a destination point;
a fuel consumption device for determining fuel consumption data indicating an amount of fuel consumed by the vehicle during the journey; and
a vehicle monitoring processor for receiving and processing the location data and the fuel consumption data.

2. The vehicle monitoring device of claim 1, wherein the fuel consumption device comprises a fuel flow meter.

3. The vehicle monitoring device of claim 1, wherein the fuel consumption device comprises a fuel pump.

4. The vehicle monitoring device of claim 1, further comprising:
an emission measurement device for determining emission data indicating an amount of emission produced by the vehicle during the journey, and wherein the vehicle monitoring processor is capable of receiving and processing the emission data.

5. The vehicle monitoring device of claim 4, wherein the emission measurement device determines the amount of emission produced by the vehicle by measuring vehicle exhaust gases.

6. The vehicle monitoring device of claim 5, wherein the emission measurement device determines the amount of emission produced by the vehicle by measuring carbon particles in the vehicles exhaust gases.

7. The vehicle monitoring device of claim 4, wherein the emission measurement device determines the amount of emission produced by the vehicle by measuring air quality surrounding the vehicle.

8. The vehicle monitoring device of claim 4, wherein the emission measurement device measures nitrogen dioxide emissions.

9. The vehicle monitoring device of claim 4, wherein the emission measurement device measures sulphur dioxide emissions.

10. The vehicle monitoring device of claim 4, wherein the emission measurement device measures carbon emissions.

11. The vehicle monitoring device of claim 1, further comprising:
a distance measurement device for determining distance data indicating a distance traveled by the vehicle during the journey, and wherein the vehicle monitoring processor is capable of receiving and processing the distance data.

12. The vehicle monitoring device of claim 11, wherein the vehicle monitoring processor compares the distance data with the location data.

13. The vehicle monitoring device of claim 1, further comprising:
a communication device for enabling two way communication between the vehicle monitoring device and a remote vehicle charging device.

14. The vehicle monitoring device of claim 13, wherein the communication device comprises a General Packet Radio System (GPRS) device.

15. The vehicle monitoring device of claim 13, wherein the communication device comprises a Short Message Service (SMS) device.

16. The vehicle monitoring device of claim 13, wherein the communication device comprises a 3G wireless system.

17. The vehicle monitoring device of claim 1, wherein the vehicle monitoring processor comprises a storage device for storing the received data.

18. The vehicle monitoring device of claim 17, wherein the vehicle monitoring processor transfers the stored data to a remote vehicle charging device at predetermined intervals.

19. The vehicle monitoring device of claim 1, wherein the vehicle monitoring processor receives the data at predetermined intervals.

20. The vehicle monitoring device of claim 1, wherein the vehicle monitoring processor requests the data at predetermined intervals.

21. The vehicle monitoring device of claim 19, wherein the predetermined intervals comprises once every two minutes; once an hour; once a day; once a week; at an end of the journey; after a predetermined distance traveled.

22. The vehicle monitoring device of claim 1, wherein the vehicle monitoring processor receives the data in real time.

23. The vehicle monitoring device of claim 1, wherein the vehicle monitoring processor requests the data in real time.

24. The vehicle monitoring device of claim 1, further comprising:
a road toll device for determining road toll data identifying road tolls passed during the journey, and wherein the vehicle monitoring processor is capable of receiving and processing the road toll data.

25. The vehicle monitoring device of claim 1, further comprising:
a presentation device for presenting data to a user in accordance with instructions from the vehicle monitoring processor.

26. The vehicle monitoring device of claim 25, wherein the presentation device comprises a visual display device.

27. The vehicle monitoring device of claim 25, wherein the presentation device comprises an audio device.

28. The vehicle monitoring device of claim 1, further comprising:
a tamper detection device, and wherein the vehicle monitoring processor is capable of receiving and processing tamper detection data from the tamper detection device.

29. The vehicle monitoring device of claim 28, wherein the tamper detection device compares the received data received at the vehicle monitoring processor with expected data to determine whether the received data has been tampered with.

30. The vehicle monitoring device of claim 29, wherein the expected data is determined based on historical received data.

31. The vehicle monitoring device of claim 28, wherein the tamper detection device comprises:
a driver recognition device for determining whether a driver is a registered driver.

32. The vehicle monitoring device of claim 1, further comprising:
a route calculation device for determining a route for the journey, and wherein the vehicle monitoring processor is capable of receiving and processing the route.

33. The vehicle monitoring device of claim 32, wherein the route calculating device is capable of determining an estimated cheapest route for the journey.

34. The vehicle monitoring device of claim 32, wherein the route calculating device is capable of indicating an alternative start time.

35. The vehicle monitoring device of claim 32, wherein the route calculating device is capable of determining an estimated quickest route for the journey.

36. The vehicle monitoring device of claim 32, wherein the route calculating device is capable of determining an estimated shortest route for the journey.

37. The vehicle monitoring device of claim 32, wherein the route calculating device is capable of determining an estimated lowest emission route for the journey.

38. The vehicle monitoring device of claim 32, wherein the route calculating device is capable of determining an estimated lowest fuel consumption route for the journey.

39. The vehicle monitoring device of claim 32, wherein the route calculating device is capable of replanning the route during the journey.

40. The vehicle monitoring device of claim 1, further comprising:
a road fee calculator for calculating a fee for the journey based on the received data.

41. The vehicle monitoring device of claim 40, further comprising:
a road fee database for storing road fee data associated with road sections of the journey, and wherein the road pricing fee calculator calculates the fee for the journey based on the received data and the road fee data.

42. The vehicle monitoring device of claim 1, further comprising:
a vehicle attribute storage device for storing attribute data about the vehicle.

43. The vehicle monitoring device of claim 42, wherein the vehicle attribute data comprises at least one of:
type of vehicle; make of vehicle; model of vehicle; engine size; fuel type; vehicle age; manufacturer predicted fuel consumption data; manufacturer predicted emission data.

44. The vehicle monitoring device of claim 1, further comprising:
a map matching device, and wherein the location data is compared with map data stored in the map matching device to determine road sections traveled by the vehicle during the journey.

45. The vehicle monitoring device of claim 1, wherein the location data further indicates time and date data of the vehicle at the location during the journey.

46. A vehicle monitoring device, comprising:
a location device for determining location data indicating a location of a vehicle during a journey between an origin point and a destination point;
an emission measurement device for determining emission data indicating an amount of emission produced by the vehicle during the journey; and
a vehicle monitoring processor for receiving and processing the location data and the emission data.

47. The vehicle monitoring device of claim 46, wherein the emission measurement device determines the amount of emission produced by the vehicle by measuring vehicle exhaust gases.

48. The vehicle monitoring device of claim 47, wherein the emission measurement device determines the amount of emission produced by the vehicle by measuring carbon particles in the vehicles exhaust gases.

49. The vehicle monitoring device of claim 46, wherein the emission measurement device determines the amount of emission produced by the vehicle by measuring air quality surrounding the vehicle.

50. The vehicle monitoring device of claim 46, wherein the emission measurement device measures nitrogen dioxide emissions.

51. The vehicle monitoring device of claim 46, wherein the emission measurement device measures sulphur dioxide emissions.

52. The vehicle monitoring device of claim 46, wherein the emission measurement device measures carbon emissions.

53. The vehicle monitoring device of claim 46, further comprising:
a distance measurement device for determining distance data indicating a distance traveled by the vehicle during the journey, and wherein the vehicle monitoring processor is capable of receiving and processing the distance data.

54. The vehicle monitoring device of claim 53, wherein the vehicle monitoring processor compares the distance data with the location data.

55. The vehicle monitoring device of claim 46, further comprising:
a communication device for enabling two way communication between the vehicle monitoring device and a remote vehicle charging device.

56. The vehicle monitoring device of claim 55, wherein the communication device comprises a General Packet Radio System (GPRS) device.

57. The vehicle monitoring device of claim 55, wherein the communication device comprises a Short Message Service (SMS) device.

58. The vehicle monitoring device of claim 55, wherein the communication device comprises a 3G wireless system.

59. The vehicle monitoring device of claim 46, wherein the vehicle monitoring processor comprises a storage device for storing the received data.

60. The vehicle monitoring device of claim 59, wherein the vehicle monitoring processor transfers the stored data to a remote vehicle charging device at predetermined intervals.

61. The vehicle monitoring device of claim 46, wherein the vehicle monitoring processor receives the data at predetermined intervals.

62. The vehicle monitoring device of claim 46, wherein the vehicle monitoring processor requests the data at predetermined intervals.

63. The vehicle monitoring device of claim 61, wherein the predetermined intervals comprises once every two minutes; once an hour; once a day; once a week; at an end of the journey; after a predetermined distance traveled.

64. The vehicle monitoring device of claim 46, wherein the vehicle monitoring processor receives the data in real time.

65. The vehicle monitoring device of claim 46, wherein the vehicle monitoring processor requests the data in real time.

66. The vehicle monitoring device of claim 46, further comprising:
a road toll device for determining road toll data identifying road tolls passed during the journey, and wherein the vehicle monitoring processor is capable of receiving and processing the road toll data.

67. The vehicle monitoring device of claim 46, further comprising: a presentation device for presenting data to a user in accordance with instructions from the vehicle monitoring processor.

68. The vehicle monitoring device of claim 67, wherein the presentation device comprises a visual display device.

69. The vehicle monitoring device of claim 68, wherein the presentation device comprises an audio device.

70. The vehicle monitoring device of claim 46, further comprising:
a tamper detection device, and wherein the vehicle monitoring processor is capable of receiving and processing tamper detection data from the tamper detection device.

71. The vehicle monitoring device of claim 70, wherein the tamper detection device compares the data received at the vehicle monitoring processor with expected vehicle data to determine whether the received data has been tampered with.

72. The vehicle monitoring device of claim 71, wherein the expected data is determined based on historical received data.

73. The vehicle monitoring device of claim 70, wherein the tamper detection device comprises:
a driver recognition device for determining whether a driver is a registered driver.

74. The vehicle monitoring device of claim 46, further comprising:
a route calculating device for determining a route for the journey, and wherein the vehicle monitoring processor is capable of receiving and processing the route.

75. The vehicle monitoring device of claim 74, wherein the route calculating device is capable of determining an estimated cheapest route for the journey.

76. The vehicle monitoring device of claim 74, wherein the route calculating device is capable of indicating an alternative start time.

77. The vehicle monitoring device of claim 74, wherein the route calculating device is capable of determining an estimated quickest route for the journey.

78. The vehicle monitoring device of claim 74, wherein the route calculating device is capable of determining an estimated shortest route for the journey.

79. The vehicle monitoring device of claim 74, wherein the route calculating device is capable of determining an estimated lowest emission route for the journey.

80. The vehicle monitoring device of claim 74, wherein the route calculating device is capable of replanning the route during the journey.

81. The vehicle monitoring device of claim 46, further comprising:
a road fee calculator for calculating a fee for the journey based on the received data.

82. The vehicle monitoring device of claim 81, further comprising:
a road fee database for storing road fee data associated with road sections of the journey, and wherein the road pricing fee calculator calculates the fee for the journey based on the received data and the road fee data.

83. The vehicle monitoring device of claim 46, further comprising:
a vehicle attribute storage device for storing attribute data about the vehicle.

84. The vehicle monitoring device of claim 83, wherein the vehicle attribute data comprises at least one of:
type of vehicle; make of vehicle; model of vehicle; engine size; fuel type; vehicle age; manufacturer predicted fuel consumption data; manufacturer predicted emission data.

85. The vehicle monitoring device of claim 46, further comprising:
a map matching device, and wherein the location data is compared with map data stored in the map matching device to determine road sections traveled by the vehicle during the journey.

86. The vehicle monitoring device of claim 46, wherein the location data further indicates time and date data of the vehicle at the location during the journey.

87. A vehicle comprising the vehicle monitoring device of claim 1.

88. A vehicle charging device, comprising:
a vehicle charging processor for receiving and processing location data indicating a location of a vehicle comprising a vehicle monitoring device during a journey between an origin point and a destination point, and fuel consumption data indicating an amount of fuel consumed by the vehicle during the journey from the vehicle monitoring device; and
a road fee calculator for calculating a fee associated with the at least one vehicle monitoring device based on the received data.

89. The vehicle charging device of claim 88, further comprising:
a received data storage device for storing the received data.

90. The vehicle charging device of claim 88, wherein the location data further indicates time and date data associated with the journey.

91. The vehicle charging device of claim 88, wherein the vehicle charging processor is capable of receiving and processing emission data indicating an amount of emission produced by the vehicle during the journey from the vehicle monitoring device.

92. The vehicle charging device of claim 88, further comprising:
a vehicle attribute storage device for storing attribute data about a vehicle comprising the at least one vehicle monitoring device.

93. The vehicle charging device of claim 92, wherein the vehicle attribute data comprises at least one of:
type of vehicle; make of vehicle; model of vehicle; engine size; fuel type; vehicle age; manufacturer predicted fuel consumption data; manufacturer predicted emission data.

94. The vehicle charging device of claim 92, wherein the road fee calculator calculates the fee associated with the at least one vehicle monitoring device based on the received data and the attribute data.

95. The vehicle charging device of claim 88, wherein the fee may be a credit or a debit.

96. The vehicle charging device of claim 88, wherein the vehicle charging processor is capable of receiving an unique driver identifier from the at least one vehicle monitoring device.

97. The vehicle charging device of claim 88, wherein the vehicle charging processor is capable of receiving an unique vehicle identifier from the at least one vehicle monitoring device.

98. The vehicle charging device of claim 88, further comprising:
a road fee database for storing road fee data associated with road sections, and wherein the road pricing fee calculator calculates the fee associated with the at least one vehicle monitoring device based on the received data and the road fee data.

99. The vehicle charging device of claim 88, further comprising:
a road toll storage device for storing toll fee data associated with road tolls.

100. The vehicle charging device of claim 99, wherein the vehicle charging processor is capable of receiving road toll data from the at least one vehicle monitoring device, and wherein the road fee calculator calculates the fee associated with the at least one vehicle monitoring device based on the road toll data and the toll fee data.

101. The vehicle charging device of claim 88, further comprising:
a communication device for enabling two way communication between the vehicle charging device and the vehicle monitoring device, and wherein the vehicle charging device provides fee data to the vehicle monitoring device.

102. The vehicle charging device of claim 88, further comprising:
a registration device for registering a driver with the vehicle charging device.

103. The vehicle charging device of claim 88, further comprising:
a registration device for registering the vehicle with the vehicle charging device.

104. The vehicle charging device of claim 88, further comprising:
a validation device.

105. The vehicle charging device of claim 104, wherein the validation device comprises a map matching device, and wherein the location data is compared with map data stored in the map matching device to determine road sections traveled by the vehicle during the journey.

106. The vehicle charging device of claim 104, wherein the validation device compares the fuel consumption data with vehicle manufacture fuel consumption data stored in the vehicle attribute storage device.

107. The vehicle charging device of claim 104, wherein the validation device compares the fuel consumption data with historical fuel consumption data stored in the received data storage device.

108. The vehicle charging device of claim 104, wherein the validation device compares road toll data with data received from road tolls.

109. The vehicle charging device of claim 104, wherein the validation device compares the emission data with vehicle manufacture emission data stored at the vehicle attribute storage device.

110. The vehicle charging device of claim 104, wherein the validation device compares the emission data with historical emission data stored in the received data storage device.

111. The vehicle charging device of claim 88, further comprising:
a historical road data storage device comprising historical data regarding a plurality of roads.

112. The vehicle charging device of claim 88, further comprising:
a tamper detection device for determining whether the received data has been tampered with.

113. The vehicle charging device of claim 112, wherein the tamper detection device compares the received data with historical received data.

114. The vehicle charging device of claim 112, wherein the tamper detection device compares the received data from the vehicle monitoring device with received data from another vehicle monitoring device.

115. The vehicle charging device of claim 112, wherein the tamper detection device compares the data received from the at least one vehicle monitoring device with third party data.

116. The vehicle charging device of claim 115, wherein the third party data comprises at least one of average speed data, and/or traffic event data.

117. The vehicle charging device of claim 88, further comprising: an invoicing unit for receiving the calculated fee associated with the at least one vehicle monitoring device from the road pricing fee calculator, and for invoicing a driver of the vehicle.

118. The vehicle charging device of claim 88, wherein the vehicle charging processor receives the data from the at least one vehicle monitoring device at predetermined intervals.

119. The vehicle charging device of claim 88, wherein the vehicle charging processor requests the data from vehicle monitoring device at predetermined intervals.

120. The vehicle charging device of claim 118, wherein the predetermined intervals comprises once every two minutes; once an hour; once a day; once a week; at the end of a journey; or after a predetermined distance traveled.

121. A vehicle charging device, comprising:
a vehicle charging processor for receiving and processing location data indicating a location of a vehicle comprising a vehicle monitoring device during a journey between an origin point and a destination point, and emission data indicating an amount of emission produced by the vehicle during the journey from the vehicle monitoring device; and
a road fee calculator for calculating a fee associated with the at least one vehicle monitoring device based on the received data.

122. The vehicle charging device of claim 121, further comprising:
a received data storage device for storing the received data.

123. The vehicle charging device of claim 121, wherein the GPS data further indicates time and date data associated with the journey.

124. The vehicle charging device of claim 121, further comprising:
a vehicle attribute storage device for storing attribute data about a vehicle comprising the at least one vehicle monitoring device.

125. The vehicle charging device of claim 124, wherein the vehicle attribute data comprises at least one of:
type of vehicle; make of vehicle; model of vehicle; engine size; fuel type; vehicle age; manufacturer predicted fuel consumption data; manufacturer predicted emission data.

126. The vehicle charging device of claim 124, wherein the road fee calculator calculates the fee associated with the at least one vehicle monitoring device based on the received data and the attribute data.

127. The vehicle charging device of claim 121, wherein the fee may be a credit or a debit.

128. The vehicle charging device of claim 121, wherein the vehicle charging processor is capable of receiving an unique driver identifier from the at least one vehicle monitoring device.

129. The vehicle charging device of claim 121, wherein the vehicle charging processor is capable of receiving an unique vehicle identifier from the at least one vehicle monitoring device.

130. The vehicle charging device of claim 121, further comprising:
a road fee database for storing road fee data associated with road sections, and wherein the road pricing fee calculator calculates the fee associated with the at least one vehicle monitoring device based on the received data and the road fee data.

131. The vehicle charging device of claim 121, further comprising:
a road toll storage device for storing toll fee data associated with road tolls.

132. The vehicle charging device of claim 131, wherein the vehicle charging processor is capable of receiving road toll data from the at least one vehicle monitoring device, and wherein the road fee calculator calculates the fee associated with the at least one vehicle monitoring device based on the road toll data and the toll fee data.

133. The vehicle charging device of claim 121, further comprising:
a communication device for enabling two way communication between the vehicle charging device and the vehicle monitoring device, and wherein the vehicle charging device provides fee data to the vehicle monitoring device.

134. The vehicle charging device of claim 121, further comprising:
a registration device for registering a driver with the vehicle charging device.

135. The vehicle charging device of claim 121, further comprising:
a registration device for registering the vehicle with the vehicle charging device.

136. The vehicle charging device of claim 121, further comprising:
a validation device.

137. The vehicle charging device of claim 136, wherein the validation device comprises a map matching device, and wherein the location data is compared with map data stored in the map matching device to determine road sections traveled by the vehicle during the journey.

138. The vehicle charging device of claim 136, wherein the validation device compares road toll data with data received from road tolls.

139. The vehicle charging device of claim 136, wherein the validation device compares the emission data with vehicle manufacture emission data stored at the vehicle attribute storage device.

140. The vehicle charging device of claim 136, wherein the validation device compares the emission data with historical emission data stored in the received data storage device.

141. The vehicle charging device of claim 121, further comprising:
a historical road data storage device comprising historical data regarding a plurality of roads.

142. The vehicle charging device of claim 121, further comprising:
a tamper detection device for determining whether the received data has been tampered with.

143. The vehicle charging device of claim 142, wherein the tamper detection device compares the received data with historical received data.

144. The vehicle charging device of claim 142, wherein the tamper detection device compares the received data from the vehicle monitoring device with received data from another vehicle monitoring device.

145. The vehicle charging device of claim 142, wherein the tamper detection device compares the data received from the at least one vehicle monitoring device with third party data.

146. The vehicle charging device of claim 145, wherein the third party data comprises at least one of average speed data, and/or traffic event data.

147. The vehicle charging device of claim 121, further comprising:
an invoicing unit for receiving the calculated fee associated with the at least one vehicle monitoring device from the road pricing fee calculator, and for invoicing a driver of the vehicle.

148. The vehicle charging device of claim 121, wherein the vehicle charging processor receives the data from the at least one vehicle monitoring device at predetermined intervals.

149. The vehicle charging device of claim 121, wherein the vehicle charging processor requests the data from vehicle monitoring device at predetermined intervals.

150. The vehicle charging device of claim 148, wherein the predetermined intervals comprises once every two minutes; once an hour; once a day; once a week; at the end of a journey; or after a predetermined distance traveled.

151. A road pricing apparatus, comprising:
a plurality of vehicle monitoring devices as claimed in claim 1;
at least one vehicle charging device as claimed in claim 88.

152. A method of determining a road usage fee, comprising:
receiving vehicle data from a vehicle monitoring device;
determining distance traveled and road section traveled by a vehicle comprising the vehicle monitoring device during a journey, time and date of the journey, and fuel consumed during the journey based on the vehicle data; and
calculating a road usage fee for the journey.

153. The method of claim 152, further comprising:
invoicing a driver of the vehicle the road usage fee.

154. The method of claim 152, further comprising:
determining an amount of emission during the journey based on the vehicle data.

155. The method of claim 152, further comprising:
comparing the received vehicle data with vehicle data received from another vehicle; and
determining whether the received vehicle data is correct based on the comparison.

156. The method of claim 152, further comprising:
comparing the received vehicle data with third party data; and
determining whether the received vehicle data is correct based on the comparison.

157. The method of claim 156, wherein the third party data comprises data regarding traffic events.

158. The method of claim 156, wherein the third party data comprises data regarding average speed of vehicles on a known road at a known time and date.

159. The method of claim 152, further comprising:
storing vehicle attribute data about the vehicle in a storage device; and
using the vehicle attribute data to calculate the road usage fee for the journey.

160. The method of claim 159, wherein the vehicle attribute data comprises:
the type of vehicle; the make of vehicle; model of vehicle; engine size; fuel type; the vehicle age; manufacture predicted fuel consumption data; manufacturer predicted emission data.

161. The method of claim 152, further comprising:
comparing the received vehicle data with expected vehicle data; and
determining whether the received vehicle data has been tampered with.

162. The method of claim 161, wherein the expected vehicle data is determined based on historical vehicle data.

163. The method of claim 152, wherein the received vehicle data comprises location data and distance traveled data, and wherein the method further comprises:
comparing the location data with the distance traveled data; and
determining whether the received vehicle data has been tampered with.

164. The method of claim 152, wherein the received vehicle data comprises location data, and wherein the method further comprises:
comparing the location data with map data stored in a map matching device; and
determining road sections traveled during the journey.

165. The method of claim 152, further comprising:
comparing time and/or date data received from a road toll device with time and/or date data received from a road toll.

166. The method of claim 152, further comprising:
comparing the fuel consumption data with vehicle manufacture fuel consumption data.

167. The method of claim 152, further comprising:
comparing the fuel consumption data with historical fuel consumption data.

168. The method of claim 154, further comprising:
comparing the emission data with vehicle manufacture emission data.

169. The method of claim 154, further comprising:
comparing the emission data with historical emission data.

170. A method of determining a road usage fee, comprising:
receiving vehicle data from a vehicle monitoring device;
determining distance traveled and road section traveled by a vehicle comprising the vehicle monitoring device during a journey, time and date of the journey, and an amount of emission during the journey based on the vehicle data; and
calculating a road usage fee for the journey.

171. The method of claim 170, further comprising: invoicing a driver of the vehicle the road usage fee.

172. The method of claim 170, further comprising:
comparing the received vehicle data with vehicle data received from another vehicle; and
determining whether the received vehicle data is correct based on the comparison.

173. The method of claim 170, further comprising:
comparing the received vehicle data with third party data; and
determining whether the received vehicle data is correct based on the comparison.

174. The method of claim 173, wherein the third party data comprises data regarding traffic events.

175. The method of claim 173, wherein the third party data comprises data regarding average speed of vehicles on a known road at a known time and date.

176. The method of claim 170, further comprising:
storing vehicle attribute data about the vehicle in a storage device; and
using the vehicle attribute data to calculate the road usage fee for the journey.

177. The method of claim 176, wherein the vehicle attribute data comprises:
the type of vehicle; the make of vehicle; model of vehicle; engine size; fuel type; the vehicle age; manufacture predicted fuel consumption data; manufacturer predicted emission data.

178. The method of claim 170, further comprising:
comparing the received vehicle data with expected vehicle data; and
determining whether the received vehicle data has been tampered with.

179. The method of claim 178, wherein the expected vehicle data is determined based on historical vehicle data.

180. The method of claim 170, wherein the received vehicle data comprises location data and distance traveled data, and wherein the method further comprises:
comparing the location data with the distance traveled data; and
determining whether the received vehicle data has been tampered with.

181. The method of claim 170, wherein the received vehicle data comprises location data, and wherein the method further comprises:
comparing the location data with map data stored in a map matching device; and
determining road sections traveled during the journey.

182. The method of claim 170, further comprising:
comparing time and/or date data received from a road toll device with time and/or date data received from a road toll.

183. The method of claim 170, further comprising:
comparing the emission data with vehicle manufacture emission data.

184. The method of claim 170, further comprising:
comparing the emission data with historical emission data.

185. A method of determining a road usage fee, the method comprising:
determining a debit based on roads used at a time of day;
determining a credit or debit based on fuel consumed as a result of fuel tax already paid;
determining a credit or debit based on low emission levels, when compared with manufactures stated levels of emissions for the vehicle;
determining a credit or debit based on low mileage over a predetermined period of time as a result of road tax already paid; and
determining a credit or debit for using roads at off peak times.
